(19) United States
(12) Patent Application Publication
(10) Pub. No.: US 2026/0299651 A1
(43) Pub. Date: Oct. 1, 2026

(54) ELECTRONIC DEVICE INCLUDING PRINTED CIRCUIT BOARDS AND SLIDABLE STRUCTURE

(71) Applicant: Samsung Electronics Co., Ltd., Suwon-si (KR)

(72) Inventors: Sungho KIM, Suwon-si (KR); Inchan SONG, Suwon-si (KR); Hyunsuk KIM, Suwon-si (KR); Youngho KIM, Suwon-si (KR); Jungwoo LEE, Suwon-si (KR)

(21) Appl. No.: 19/426,990

(22) Filed: Dec. 19, 2025

Related U.S. Application Data
(63) Continuation of application No. PCT/KR2025/021431, filed on Dec. 11, 2025.

(30) Foreign Application Priority Data
Mar. 31, 2025 (KR) 10-2025-0041647
May 2, 2025 (KR) 10-2025-0058571

(51) Int. Cl. G06F 1/16; H04M 1/02

(52) U.S. Cl. CPC G06F 1/1683; G06F 1/1698; H04M 1/0237; H04M 1/0268; H04M 1/0277

(57) ABSTRACT

An electronic device includes a housing that includes a first housing part and a second housing part that are movably coupled to each other, the second housing part including a conductive portion, a flexible display, a first printed circuit board (PCB) disposed in the first housing part, a second PCB disposed in the second housing part and electrically connected to the conductive portion, a third PCB disposed in the second housing part, and an electrical path extending from the second PCB, across a lateral side of the flexible display, to the third PCB. The third PCB is electrically connected to the second PCB via the electrical path.

### CROSS-REFERENCE TO RELATED APPLICATIONS

This application is a continuation of International Application No. PCT/KR2025/021431 designating the United States, filed on Dec. 11, 2025, in the Korean Intellectual Property Receiving Office and claiming priority to Korean Patent Application Nos. 10-2025-0041647, filed on Mar. 31, 2025, and 10-2025-0058571, filed on May 2, 2025, in the Korean Intellectual Property Office, the disclosures of each of which are incorporated by reference herein in their entireties.

### BACKGROUND

### Field

The disclosure relates to an electronic device including printed circuit boards and a slidable structure.

### Description of Related Art

An electronic device may include a housing including housing parts that are movably connected (or coupled) to each other, and a flexible display including a display area. For example, the housing may include a first housing part and a second housing part, and the first housing part and the second housing part may be movably connected to each other. The housing may provide an extended state (or a slide-out state) that provides a relatively large display area, and a retracted state (or a slide-in state) that provides a relatively small display area. Electronic components included in the first housing part and electronic components included in the second housing part may be electrically connected to each other through a connecting member (e.g., a printed circuit board).

The above-described information may be provided as related art for the purpose of helping the understanding of the present disclosure. No assertion or determination is made as to whether any of the above-described content may be applied as prior art related to the present disclosure.

### SUMMARY

An electronic device is disclosed. The electronic device may comprise a housing. The housing may include a first housing part and a second housing part configured to movably engage with the first housing part to provide a retracted state of the housing and an extended state of the housing. The second housing part may include a frame configured to accommodate a battery, and a slide cover at least partially surrounding the frame to accommodate the frame. The electronic device may comprise a flexible display disposed at the first housing part and the second housing part such that a size of an area of the flexible display that is visible from a front side of the housing changes as a state of the housing is changed between the retracted state and the extended state. The flexible display may include a first portion visible to the front side of the housing based on the housing being in the retracted state, and a second portion that is not visible to the front side and is at least partially positioned at a space between the frame and the slide cover. The electronic device may comprise a first printed circuit board (PCB) disposed at the first housing part. The electronic device may comprise a second PCB disposed at the slide cover. The electronic device may comprise a third PCB disposed at the frame. The second PCB may be electrically connected to the first PCB through the third PCB. The second PCB and the third PCB may be electrically connected to each other at a space between a lateral side of the frame and a lateral side of the slide cover corresponding to the lateral side of the frame. The first PCB and the third PCB may be electrically connected to each other through a connecting member a flexible portion that is at least partially deformed in response to a movement of the second housing part with respect to the first housing part. Based on the state of the housing being changed from the extended state to the retracted state, the second portion of the flexible display may be inserted into a space between the second PCB and the third PCB.

An electronic device is disclosed. The electronic device may comprise a housing. The housing may include a first housing part and a second housing part configured to movably engage with the first housing part to provide a retracted state of the housing and an extended state of the housing. The second housing part may include a conductive portion configured to function as an antenna radiator. The electronic device may comprise a flexible display coupled to the first housing part and the second housing part such that a size of an area of the flexible display that is visible from a front side of the housing changes as a state of the housing is changed between the retracted state and the extended state. The flexible display may include a portion positioned within the housing when the housing is in the retracted state. The electronic device may comprise a first printed circuit board (PCB) disposed in the first housing part. At least one processor comprising processing circuitry may be disposed on the first PCB. The electronic device may comprise a second PCB, disposed in the second housing part to be positioned behind the portion of the flexible display when the housing is in the retracted state, and electrically connected to the conductive portion of the second housing part. The electronic device may comprise a third PCB disposed in the second housing part and electrically connected to the first PCB. The portion of the flexible display may be positioned between the second PCB and the third PCB when the housing is in the retracted state. The electronic device may comprise an electrical path extending from the second PCB, across a lateral side of the portion of the flexible display perpendicular to a direction in which the second housing part moves when the state of the housing is changed, to the third PCB. The third PCB may be electrically connected to the second PCB via the electrical path.

An electronic device is disclosed. The electronic device may comprise a housing including a first housing part and a second housing part. The second housing part may include a conductive portion and may be configured to slide-in and slide-out with respect to the first housing part. The electronic device may comprise a display disposed at the housing such that a size of a display area visible from the outside of the electronic device changes as the second housing part slides-in or slides-out with respect to the first housing part. The electronic device may comprise a printed circuit board (PCB) accommodated in the first housing part, wherein at least one processor, comprising processing circuitry, is disposed thereon. The electronic device may include a sliding module including a support configured to support the slide-in and slide-out of the second housing part with respect to the first housing part. The sliding module may include a base frame, a first guide member and a second guide member respectively disposed at a first side and a second side opposite to each other of the base frame, the first guide member including a first through hole formed therein, a multi-bar track configured to move along an upper side or a lower side of the base frame, guided by the first guide member and the second guide member, and a slide cover substantially covering the base frame, the first guide member, and the second guide member. The slide cover may include a second through hole formed in a first sidewall facing the first guide member or in an upper side facing the base frame. The electronic device may include a signal line member electrically connecting the conductive portion of the second housing part and the at least one processor. The signal line member may include a first line portion disposed at the upper side of the base frame, a second line portion disposed at the upper side of the slide cover, and a third line portion connecting the first line portion and the second line portion and disposed to pass through the first through hole and the second through hole.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an electronic device in a network environment according to various embodiments.

FIG. 2 is a front view of an electronic device when a housing is in a first state.

FIG. 3 is a rear view of an electronic device when a housing is in a first state.

FIG. 4 is a front view of an electronic device when a housing is in a second state.

FIG. 5 is a rear view of an electronic device when a housing is in a second state.

FIG. 6 is a rear view of an electronic device with a second rear cover omitted.

FIG. 7 is a rear view of an electronic device with a first rear cover, a second rear cover, and a slide cover omitted.

FIG. 8A is a cross-sectional view of a housing in a first state, taken along line A-A' of FIG. 6.

FIG. 8B is a cross-sectional view of an electronic device in which the housing of FIG. 8A is changed to a second state.

FIG. 9A illustrates a first printed circuit board (PCB), a second PCB, and a third PCB.

FIG. 9B is an exploded perspective view of an electronic device.

FIG. 9C is an exploded perspective view of an electronic device in which a first housing part, guide members, and a frame are coupled.

FIG. 10 is a cross-sectional view of a housing in a first state, taken along line B-B' of FIG. 6.

FIG. 11 is a partial exploded perspective view of an electronic device.

FIG. 12 illustrates an electrical path supported by a side plate.

FIG. 13 illustrates a is a partial perspective view illustrating a guide member.

FIG. 14 illustrates an electrical path supported by a protruding portion of a guide member.

FIG. 15 illustrates signal lines included in an electrical path.

FIG. 16 illustrates an electronic device including a third printed circuit board (PCB) spaced apart from a battery.

FIG. 17 illustrates one or more electronic components electrically connected to a second printed circuit board (PCB).

FIG. 18 illustrates a seating structure of a second housing part for fixing an electrical path.

FIG. 19 is a cross-sectional view of the electronic device of FIG. 18, taken along line C-C'.

FIG. 20 illustrates a seating structure of a guide member for fixing an electrical path.

FIG. 21 illustrates an electrical path connected to a second printed circuit board (PCB).

FIG. 22 illustrates a soldering structure of flexible portions.

### DETAILED DESCRIPTION

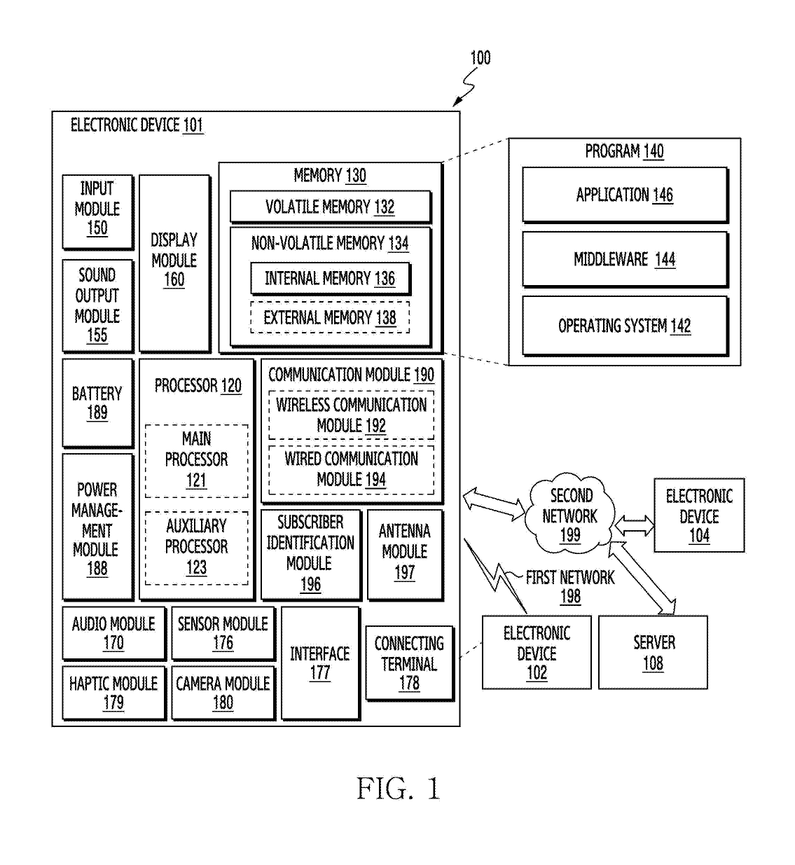

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. For example, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

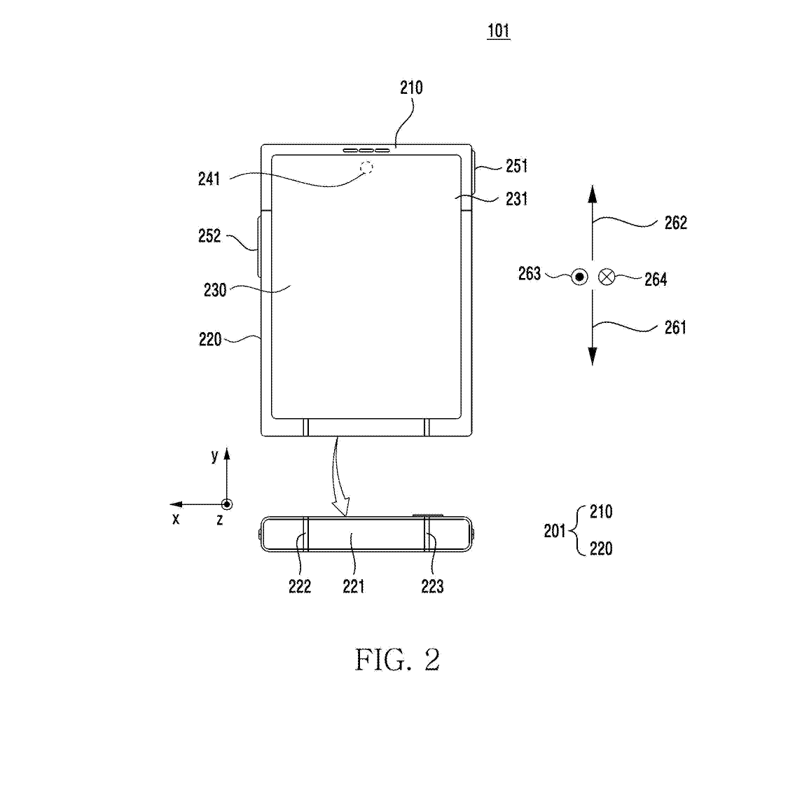

For example, the display of the display module 160 may be flexible. At least a portion of the display having flexibility may be rollable into a housing (e.g., a housing 201 of FIG. 2) of the electronic device 101 or may slide into the housing 201. The display may include a display area that displays visual information. A size of the display area may change according to a size of at least a portion of the display that is rolled into the housing 201 or slid into the housing 201. For example, the housing 201 of the electronic device 101 may provide a plurality of states, including a first state that provides the display area having a first size and a second state that provides the display area having a second size larger than the first size. The electronic device 101 may be referred to as a slidable device or a rollable device in terms of including housing 201 parts that are movably connected to each other. A state of the housing 201 to be described below may be referred to as a state of the electronic device 101.

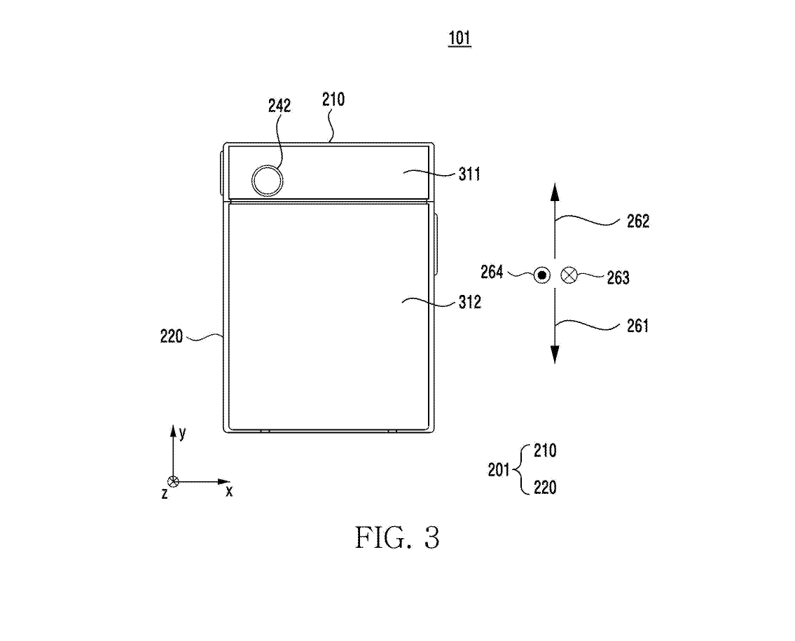

For example, the first state is described in greater detail below with reference to FIGS. 2 and 3.

FIG. 2 is a front view of an electronic device when a housing is in a first state.

Referring to FIG. 2, the above-described electronic device (e.g., the electronic device 101 of FIG. 1) may have a slidable structure. For example, the electronic device 101 may include a housing 201 including a first housing part 210 and a second housing part 220. The second housing part 220 may be movably engaged with the first housing part 210 to provide a first state (e.g., a retracted state or a slide-in state) of the housing 201 or a second state (e.g., an extended state or a slide-out state) of the housing 201 to be described later. For example, the second housing part 220 may be movably connected to (or engaged with) the first housing part 210 in a first direction 261, or in a second direction 262 opposite to the first direction 261. The first housing part 210 may be referred to as a first housing, and the second housing part 220 may be referred to as a second housing.

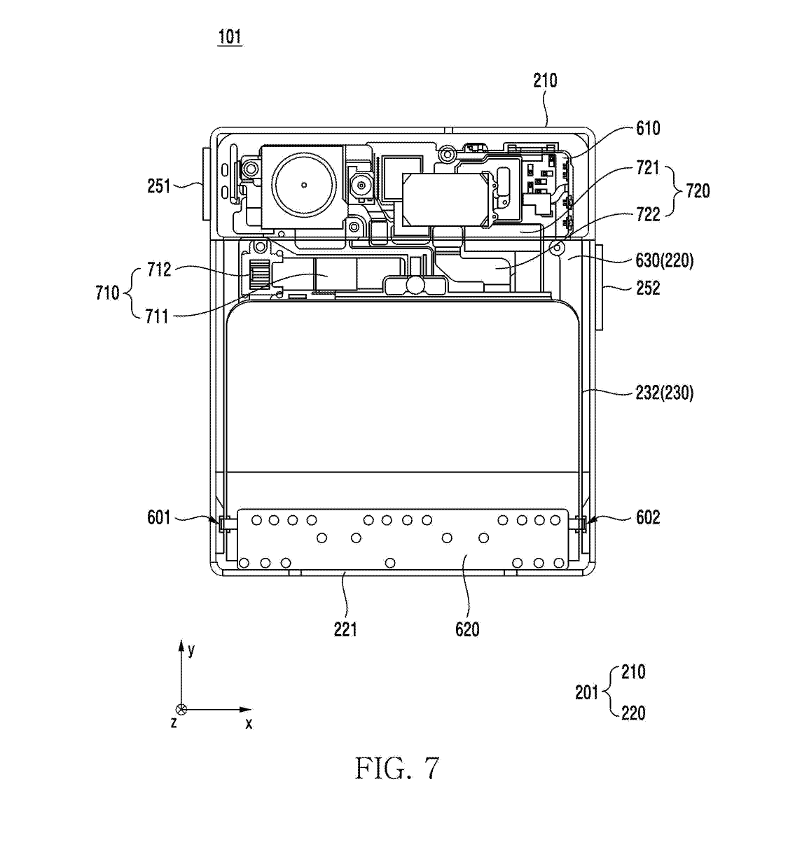

In the present disclosure, it is described that the second housing part 220 moves with respect to the first housing part 210, but the electronic device 101 of the present disclosure is not limited thereto. For example, the housing 201 may have a structure in which a state of the housing 201 may change according to a change in a relative positional relationship between the first housing part 210 and the second housing part 220. The relative positional relationship between the first housing part 210 and the second housing part 220 may be changed by a driving mechanism (e.g., a driving mechanism 710 of FIG. 7) to be described later. For example, the first housing part 210 may be movable with respect to the second housing part 220 by the driving mechanism 710. For example, both the first housing part 210 and the second housing part 220 may be movable by the driving mechanism 710. The driving mechanism 710 may include a motor (e.g., a motor 711 of FIG. 7), a pinion gear (e.g., a pinion gear 712 of FIG. 7) configured to rotate by the motor 711, by being coupled to a rotation axis of the motor 711, and a rack gear engaged with the pinion gear 712. The motor 711 may rotate the pinion gear 712 in response to a user input, and the rack gear may be configured to move in the first direction 261 or the second direction 262 based on the rotation of the pinion gear 712. The movement of the rack gear may cause the movement of the second housing part 220 with respect to the first housing part 210.

For example, the housing 201 may be in the first state. In the first state of the housing 201, the second housing part 220 may be movable with respect to the first housing part 210 in the first direction 261 among the first direction 261 and the second direction 262. For example, in the first state of the housing 201, the second housing part 220 may be substantially not movable with respect to the first housing part 210 in the second direction 262. The first direction 261 may be referred to as a direction in which the second housing part 220 moves away from the first housing part 210. The second direction 262 may be referred to as a direction in which the second housing part 220 moves closer to the first housing part 210.

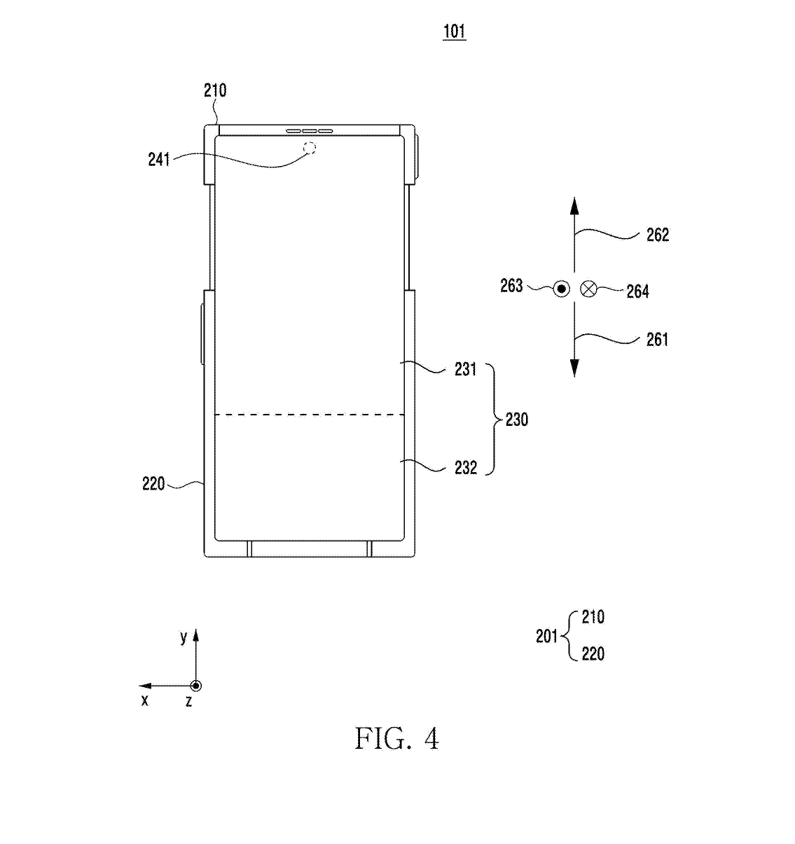

The electronic device 101 according to an embodiment may include a flexible display 230. The flexible display 230 may be coupled to the first housing part 210 and the second housing part 220. A size of an area (e.g., a display area) of the flexible display that is visible from a front side (e.g., a side of the housing 201 facing a third direction 263 of FIG. 2) of the housing 201 may change as the state of the housing 201 is changed between the first state and the second state. For example, the flexible display 230 may provide a display area having the smallest size in the first state of the housing 201. For example, in the first state of the housing 201, the display area of the flexible display 230 may correspond to a first portion 231. The first portion 231 of the flexible display 230 may be referred to as a portion visible from the outside of the housing 201, independently of the state of the housing 201. For example, the first portion 231 may be substantially flat, independently of the state of the housing 201. In the first state of the housing 201, at least a portion of a second portion (e.g., a second portion 232 of FIG. 4) of the flexible display 230, which is different from the first portion 231, may be positioned within the housing 201. In the first state of the housing 201, the second portion 232 may be substantially covered by the housing 201. In the first state of the housing 201, the second portion 232 may be at least partially rolled into the housing 201. The first state of the housing 201 may be referred to as a slide-in state or a closed state. Alternatively, the first state of the housing 201 may be referred to as a retracted state in terms of providing a display area having the smallest size. In the first state of the housing 201, the electronic device 101 having a small size may enhance portability.

According to an embodiment, the electronic device 101 may include a camera 241 (e.g., the camera module 180 of FIG. 1) disposed in the first housing part 210 to face a front side of the electronic device 101. For example, the camera 241 may face the third direction 263. The camera 241 may be referred to as a front camera in terms of facing the front side of the electronic device 101. The camera 241 may be positioned below the first portion 231 by being disposed in the first housing part 210 to overlap with the first portion 231 of the flexible display 230. The camera 241 may include an under display camera (UDC) or a punch-hole camera.

According to an embodiment, the second housing part 220 may include a conductive portion 221. For example, the conductive portion 221 may define (or form) at least a portion of a lateral side of the housing 201 facing the first direction 261. The conductive portion 221 may be electrically isolated from another portion of the second housing part 220 by non-conductive portions 222 and 223. For example, the second housing part 220 may include a first non-conductive portion 222 in contact with a side of the conductive portion 221, and a second non-conductive portion 223 in contact with another side of the conductive portion 221. The conductive portion 221 may extend from the first non-conductive portion 222 to the second non-conductive portion 223. However, the conductive portion 221 of the present disclosure is not limited thereto. For example, the conductive portion 221 may define (or form) at least a portion of lateral sides of the second housing part 220.

According to an embodiment, the conductive portion 221 may be configured to function as an antenna radiator. For example, radio frequency (RF) signals transmitted from the electronic device 101 to an external electronic device may be radiated through the conductive portion 221. RF signals received by the electronic device 101 from the external electronic device may be received through the conductive portion 221.

The electronic device 101 according to an embodiment may include one or more key buttons (e.g., a first key button 251 and/or a second key button 252). For example, the one or more key buttons may be disposed on each of both lateral sides of the housing 201, or may be disposed on one of the both lateral sides of the housing 201. The one or more key buttons may be exposed to the outside of the housing 201. The one or more key buttons may be configured to receive a user input. For example, the one or more key buttons may include the first key button 251 disposed on a lateral side of the housing 201 and the second key button 252 disposed on the other lateral side of the housing 201. For example, the first key button 251 may be disposed on a lateral side of the first housing part 210, and the second key button 252 may be disposed on a lateral side of the second housing part 220.

FIG. 3 is a rear view of an electronic device when a housing is in a first state.

Referring to FIG. 3, a housing 201 may include rear covers 311 and 312 that cover a rear side (e.g., a side of the electronic device 101 facing a fourth direction 264) of an electronic device 101. For example, the housing 201 may include a first rear cover 311 covering at least a portion of a rear side of a first housing part 210 and a second rear cover 312 covering at least a portion of a rear side of a second housing part 220. Each of the rear covers 311 and 312 may include glass material and may be referred to as back glass.

The electronic device 101 according to an embodiment may include a camera 242 disposed in the first housing part 210 to face the rear side of the electronic device 101. For example, the camera 242 may face the fourth direction 264. The camera 242 may be referred to as a rear camera in terms of facing the rear side of the electronic device 101. The first rear cover 311, which covers at least a portion of the rear side of the first housing part 210, may define an opening corresponding to the camera 242. The opening may be covered by a substantially transparent window. The camera 242 may be configured to obtain light through the window. The camera 242 may be configured to generate an image and/or a video based on the light obtained through the window.

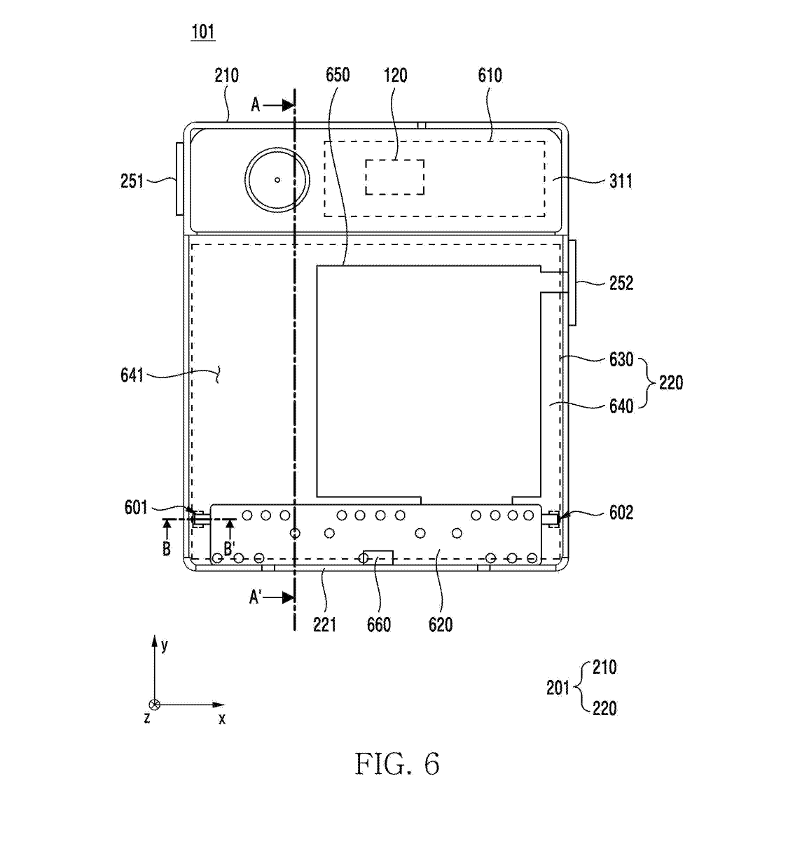

The electronic device 101 may be changed from the first state (or a second state) to the second state (or the first state). In an example, the state of the housing 201 may be changed from the first state to the second state in response to a user input received through the one or more key buttons. For example, when the one or more key buttons are pressed for a reference time or longer, the electronic device 101 may be configured to control the driving mechanism 710 to change the state of the housing 201. However, the present disclosure is not limited thereto. For example, a state of the housing 201 may be changed in response to a touch input on a visual object displayed on a flexible display 230. For example, the state of the housing 201 may be changed in response to a voice input received through a microphone (e.g., a microphone 660 of FIG. 6). For example, the state of the housing 201 may be changed in response to an external force applied to the first housing part 210 and/or the second housing part 220. For example, the state of the housing 201 may be changed in response to a user input identified from an external electronic device (e.g., a smart watch) connected to the electronic device 101.

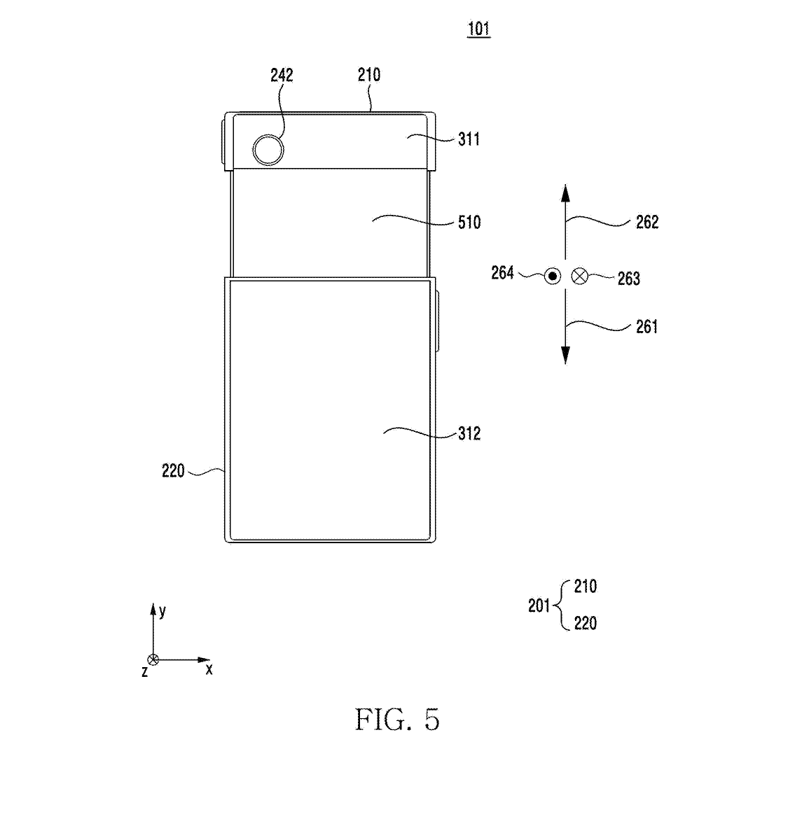

For example, the second state different from the first state is described in greater detail below with reference to FIGS. 4 and 5.

FIG. 4 is a front view of an electronic device when a housing is in a second state. FIG. 5 is a rear view of an electronic device when a housing is in a second state.

Referring to FIG. 4, a housing 201 may be in the second state. In a second state of a housing 201, a second housing part 220 may be movable with respect to a first housing part 210 in a second direction 262 among a first direction 261 and the second direction 262. For example, in the second state of the housing 201, the second housing part 220 may be substantially not movable with respect to the first housing part 210 in the first direction 261.

According to an embodiment, a flexible display 230 may provide a display area having the largest size in the second state of the housing 201. For example, in the second state of the housing 201, the display area of the display may correspond to at least a portion of a first portion 231 and a second portion 232. At least a portion of the second portion 232, which was positioned within the housing 201 in the first state of the housing 201, may be visible(or exposed) to the outside of the housing 201 in the second state of the housing 201. The second state of the housing 201 may be referred to as a slide-out state or an open state. Alternatively, the second state of the housing 201 may be referred to as an extended state in terms of providing a display area having the largest size. For example, when the housing 201 is in the second state, the display area of the flexible display 230 may provide a large screen. When the electronic device 101 is in the second state, an image or a video displayed on the display area of the flexible display 230 may be larger than an image or a video displayed on the display area of the flexible display 230 when the electronic device 101 is in the first state.

Referring to FIG. 5, the first housing part 210 may include a rear plate 510. The rear plate 510 may define a portion of a rear side (e.g., a side of the first housing part 210 facing a fourth direction 264) of the first housing part 210 that is positioned outside the second housing part 220 when the housing 201 is in the second state (e.g., the extended state or the slide-out state). As the housing 201 is changed from the first state to the second state, the second housing part 220 may move with respect to the first housing part 210 in the first direction 261. When the second housing part 220 moves with respect to the first housing part 210 in the first direction 261, a portion of the rear side of the first housing part 210, which was positioned in the housing 201, may be positioned outside the second housing part 220. The rear plate 510 may cover an internal space of the first housing part 210 by defining the portion of the rear side of the first housing part 210 that was positioned outside the second housing part 220. When the housing 201 is changed from the second state to the first state (e.g., a retracted state or a slide-in state), the second housing part 220 may move with respect to the first housing part 210 in the second direction 262. As the second housing part 220 moves in the first direction 261, the rear plate 510 may be inserted into the second housing part 220. When the housing 201 is in the first state, the rear plate 510 may be covered by the second housing part 220.

The electronic device 101 may provide states between the first state and the second state. For example, the states may be referred to as a partially slide-in state or a partially slide-out state. A size of the display area in the states may be larger than a size of the display area in the first state and smaller than a size of the display area in the second state.

FIG. 6 is a rear view of an electronic device with a second rear cover omitted. FIG. 7 is a rear view of an electronic device with a first rear cover, a second rear cover, and a slide cover omitted.

Referring to FIG. 6, a second housing part 220 may include a frame 630 and a slide cover 640. The slide cover 640 may be coupled to the frame 630 and may be configured to move with the frame 630. The slide cover 640 may surround at least a portion of the frame 630 to cover a rear side 641 of the frame 630. For example, when a rear side of an electronic device 101 is viewed from behind (e.g., in the +z direction), the frame 630 may not be visible from the outside of the housing 201 by the slide cover 640.

The electronic device 101 according to an embodiment may include a first printed circuit board (PCB) 610 disposed in a first housing part 210. The first PCB 610 may be referred to as a main printed circuit board of the electronic device 101. For example, at least one processor (e.g., the processor 120 of FIG. 1) including processing circuitry may be disposed on the first PCB 610.

The electronic device 101 according to an embodiment may include a second PCB 620 disposed in the second housing part 220. For example, the second PCB 620 may be disposed on a rear side (e.g., the rear side 641 of the slide cover 640) of the second housing part 220. Although not illustrated in FIG. 6, the rear side 641 of the slide cover 640 may be covered by a second rear cover (e.g., the second rear cover 312 of FIG. 5). When the second rear cover 312 is coupled to the slide cover 640 to cover the rear side of the slide cover 640, the second PCB 620 may be covered by the second rear cover 312.

The electronic device 101 according to an embodiment may include one or more electronic components electrically connected to the second PCB 620. For example, the one or more electronic components may include a conductive portion 221 electrically connected to the second PCB 620 and configured to function as an antenna radiator. For example, the one or more electronic components may include an inductive coil 650 for wireless charging or short-range wireless communication (SRC). For example, the one or more electronic components may include a microphone 660 electrically connected to the second PCB 620. For example, the one or more electronic components may include a second key button 252 for receiving a user input. The above-described one or more electronic components are merely examples, and the one or more electronic components electrically connected to the second PCB 620 are not limited to the examples described above.

FIG. 7 illustrates the electronic device 101 with the slide cover (e.g., the slide cover 640 of FIG. 6) omitted from FIG. 6. Referring to FIG. 7, when the housing 201 is in a first state (e.g., a retracted state or a slide-in state), a second portion 232 of a flexible display 230 may be positioned within the housing 201.

In the electronic device 101, to provide a compact size and to increase a movement distance of the second housing part 220 with respect to the first housing part 210, an area of the second portion 232 of the flexible display 230, which is positioned within the housing 201, may be increased when the housing 201 is in the first state (e.g., a retracted state or a slide-in state). As the area of the second portion 232 positioned within the housing 201 increases, when the housing 201 is in the first state, an overall length of the housing 201 may be reduced, and the movement distance of the second housing part 220 with respect to the first housing part 210 may be increased. As the overall length of the housing 201 is reduced and the movement distance of the second housing part 220 increases when the housing 201 is in the first state, usability by a slidable structure may be improved.

For example, the electronic device 101 may include one or more connecting members 720 connected to the first PCB 610. The one or more connecting members 720 may include a first connecting member 721 for transferring first signals (e.g., baseband signals) and/or a second connecting member 722 for delivering second signals (e.g., RF signals). The one or more connecting members 720 may have flexibility to be bent or unfolded according to a movement of the second housing part 220. The one or more connecting members 720 may include a flexible portion that is at least partially deformed in response to a movement of the second housing part 220 with respect to the first housing part 210. For example, the first connecting member 721 and/or the second connecting member 722 may include a flexible printed circuit board. The second connecting member 722 for delivering RF signals may be referred to as a flexible RF cable.

Since the at least the one processor 120 is included in the first PCB 610 in the first housing part 210, and the second PCB 620 is included in the second housing part 220, a structure for electrically connecting the at least the one processor 120 and the one or more electronic components disposed on the second PCB 620 may be required. As described above, for the electronic device 101 with a compact size, in a case in which the area of the second portion 232 of the flexible display 230, which is positioned within the housing 201, increases when the housing 201 is in the first state, electrical connection between the first PCB 610 and the second PCB 620 may be difficult due to overlap between the second portion 232 and a rear plate (e.g., the rear plate 510 of FIG. 5).

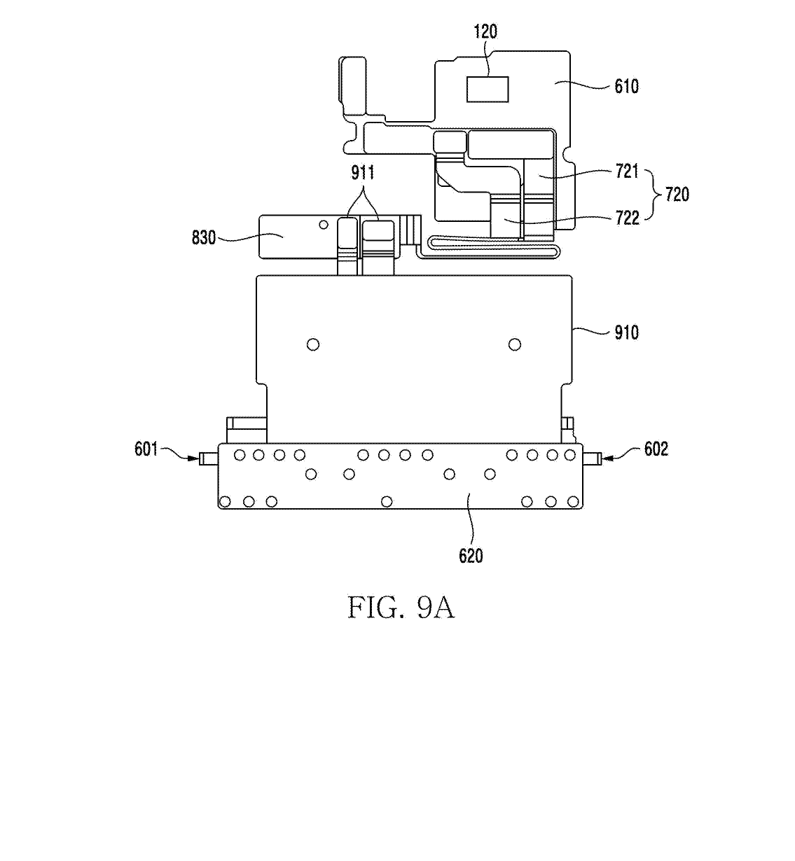

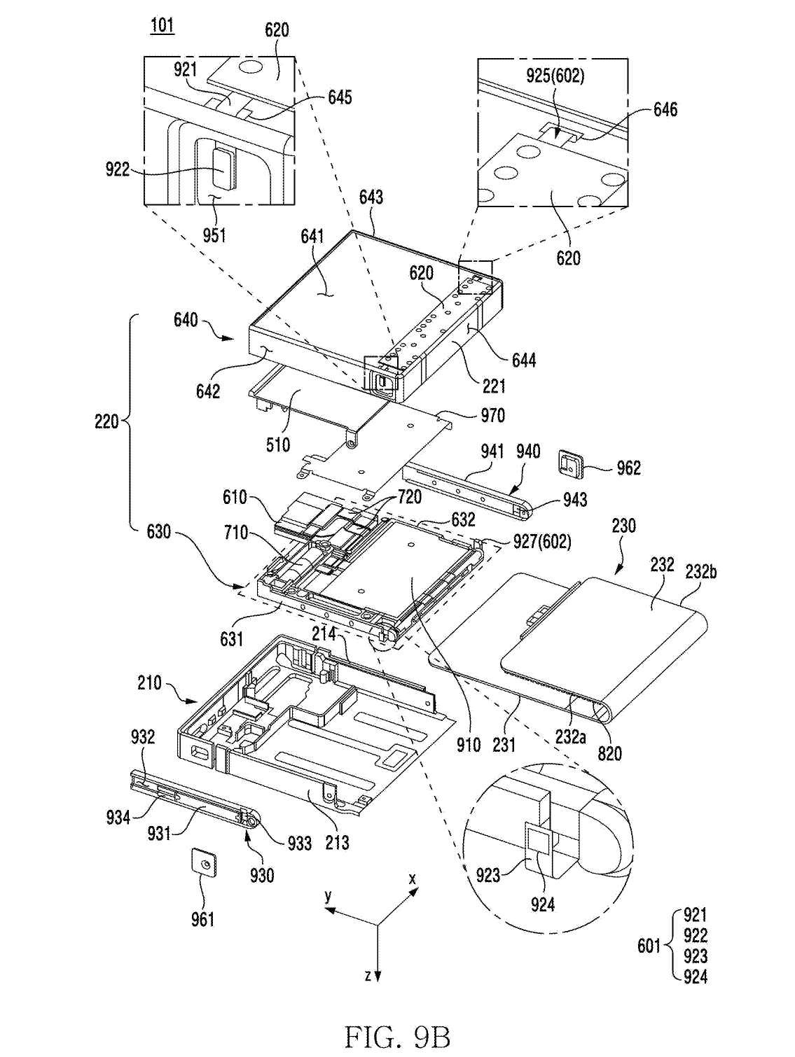

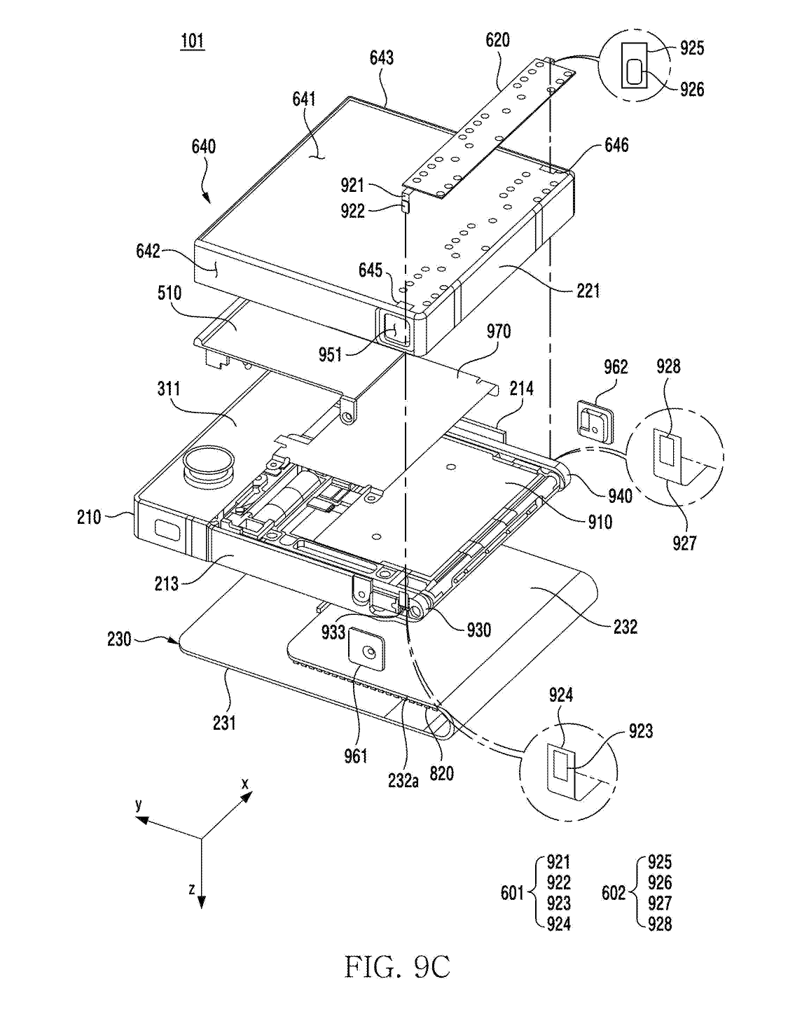

The electronic device 101 according to an embodiment may include a third PCB (e.g., a third PCB 910 of FIG. 9A) accommodated in the second housing part 220 (e.g., the frame 630), and an electrical path (e.g., the electrical path 601 and/or another electrical path 602 of FIG. 6) electrically connecting the second PCB 620 and the third PCB 910, in order to electrically connect the second PCB 620 to the first PCB 610. The electrical path 601 and/or the other electrical path 602 may traverse lateral sides (e.g., lateral sides 232a and 232b of FIG. 9b) of the second portion 232 of the flexible display 230. In the present disclosure, the electrical path may be referred to as a physical element including one or more transmission lines for transmitting signals. The electrical path may be referred to as a path portion, a connecting portion, or a line portion.

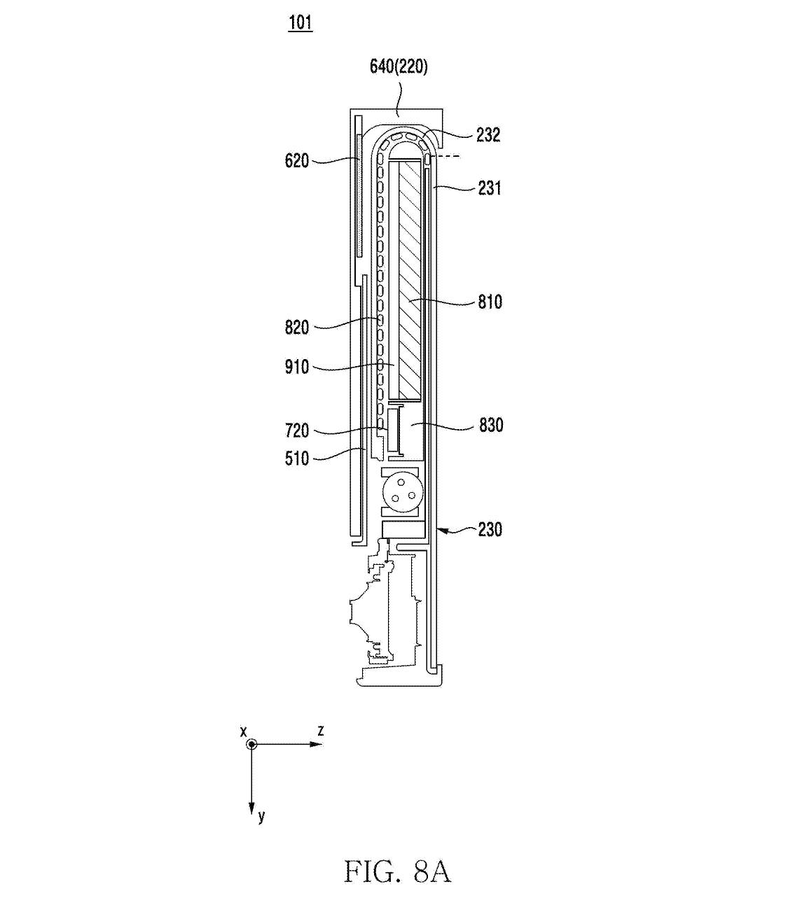

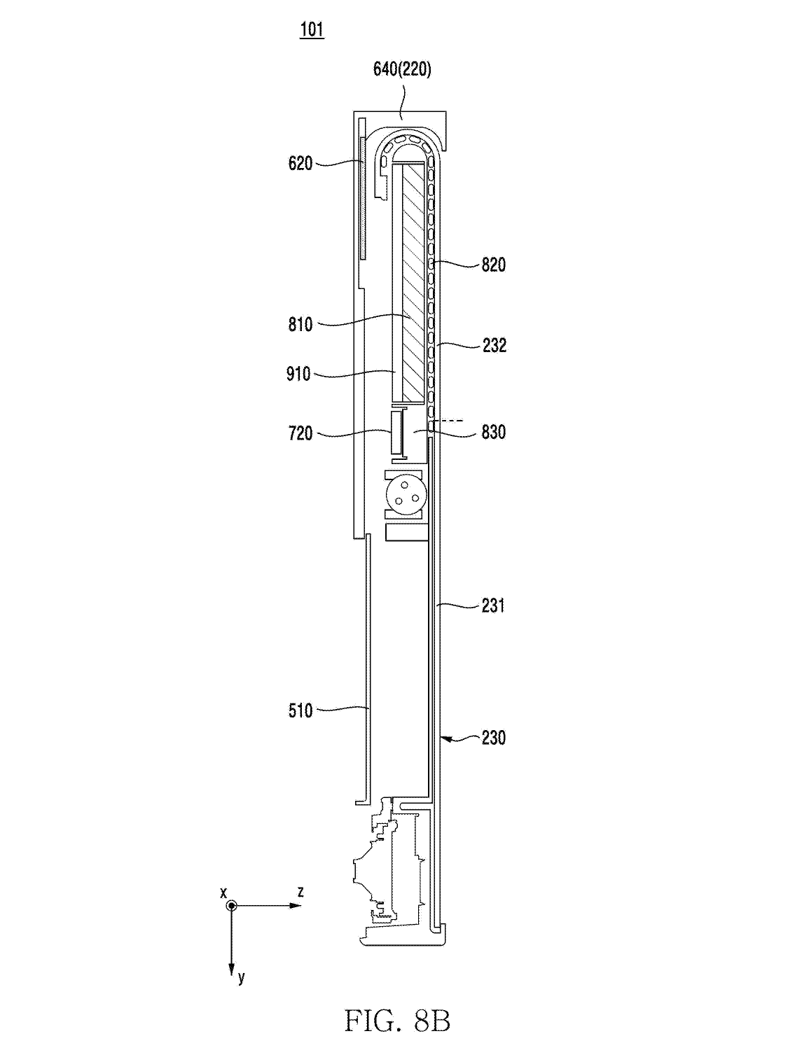

Hereinafter, with reference to FIGS. 8A and 8B, an overlapping structure of the rear plate 510 and the second portion 232 is described in greater detail.

FIG. 8A is a cross-sectional view of a housing in a first state, taken along line A-A' of FIG. 6. FIG. 8B is a cross-sectional view of an electronic device in which the housing of FIG. 8A is changed to a second state.

Referring to FIG. 8A, a rear plate 510 may overlap with a second portion 232 of a flexible display 230 positioned within a housing 201 when the housing 201 is in the first state (e.g., a retracted state or a slide-in state). For a compact size, as an area of the second portion 232 of the flexible display 230 positioned within the housing 201 increases, the rear plate 510 of a first housing part 210 may overlap with at least a portion of the second portion 232. A second printed circuit board (PCB) 620 may be positioned behind (e.g., in a -z direction) the second portion 232 of the flexible display 230 when the housing 201 is in the first state.

An electronic device 101 according to an embodiment may include a multi-bar track 820 supporting at least a portion of the flexible display 230. The multi-bar track 820 may include a plurality of bars supporting at least a portion of a rear side of the flexible display 230. The plurality of bars may move together with the flexible display 230.

As described above, the electronic device 101 may include one or more connecting members (e.g., the one or more connecting members 720 of FIG. 7) electrically connected to a first PCB (e.g., the first PCB 610 of FIG. 6). The one or more connecting members 720 may be connected to a connector structure 830 in a second housing part 220. Since the second PCB 620 is disposed on a rear side (e.g., in the -z axis direction) of a slide cover 640 of the second housing part 220, a portion of the second PCB 620 needs to be inserted into the slide cover 640 of the second housing part 220 for the second PCB 620 to be electrically connected to the first PCB 610 through the connector structure 830 and the one or more connecting members 720 in the second housing part 220. In order for a portion of the second PCB 620 to be connected to the one or more connecting members 720, the portion of the second PCB 620 needs to extend between the rear plate 510 and the second portion 232 of the flexible display 230, which overlap with each other, and therefore, the portion of the second PCB 620 may be in contact with the second portion 232 of the flexible display 230. The portion of the second PCB 620 in contact with the second portion 232 may physically interfere with the second portion 232 of the flexible display 230, which is configured to move together with a movement of the second housing part 220.

Referring to FIG. 8B, when the housing 201 is changed from the first state to a second state (e.g., an extended state or a slide-out state), a portion of the second portion 232 may move outside the housing 201. When the housing 201 is in the second state, the second portion 232 of the flexible display 230 may not overlap with the rear plate 510. In a case in which a portion of the second PCB 620 is inserted into the slide cover 640 of the second housing part 220 for connection with the one or more connecting members 720, there may be no structure for supporting the portion of the second PCB 620. In a case in which the portion of the second PCB 620 is not supported by a physical structure, the stability of an electrical connection through the portion of the second PCB 620 may deteriorate.

The electronic device 101 according to an embodiment may include a third PCB 910 for electrically connecting the first PCB (e.g., the first PCB 610 of FIG. 6) included in the first housing part 210 and the second PCB 620 included in the second housing part 220. Referring to FIGS. 8A and 8B, the third PCB 910 may be disposed in the second housing part 220. For example, the third PCB 910 may at least partially overlap with a battery 810 accommodated in the second housing part 220.

The electronic device 101 according to an embodiment may include an electrical path (e.g., an electrical path 601 of FIG. 9A) that electrically connects the second PCB 620 and the third PCB 910. The electrical path may laterally across the electronic device 101 to electrically connect the second PCB 620 and the third PCB 910. For example, the electrical path may extend from the second PCB 620, across a lateral side (e.g., a lateral side 232a of FIG. 9B) of the second portion 232 of the flexible display 230, to the third PCB 910. As described below, the electronic device 101 may include guide members (e.g., a first guide member 930 and a second guide member 940 of FIG. 9B) connected to the first housing part 210 and a frame (e.g., a frame 630 of FIG. 9B) of the second housing part 220 and configured to guide a movement of the second housing part 220. Since each of the guide members is disposed at each of lateral sides of the second housing part 220, at least one of the guide members may include a through hole (e.g., a second through hole 933 and/or a fourth through hole 943 of FIG. 9B) for the electrical path 601 to pass through.

Hereinafter, structures for electrically connecting the second PCB 620 and the third PCB 910 are described in greater detail.

FIG. 9A illustrates a first printed circuit board (PCB), a second PCB, and a third PCB. FIG. 9B is an exploded perspective view of an electronic device. FIG. 9C is an exploded perspective view of an electronic device in which a first housing part, guide members, and a frame are assembled.

Referring to FIG. 9A, at least one processor 120 may be disposed on a first PCB 610. One or more connecting members 720 may be connected to the first PCB 610. The one or more connecting members 720 may be respectively connected to the first PCB 610 in a first housing part 210 and to a connector structure 830 in a second housing part 220. The one or more connecting members 720 may include a first connecting member 721 for providing first signals (e.g., baseband signals) and/or a second connecting member 722 for providing second signals (e.g., RF signals). The one or more connecting members 720 may electrically isolate a first signal and a second signal by respectively including a first connecting member 721 for transmitting (or delivering) the first signal and a second connecting member 722 for transmitting the second signal. As described above, the one or more connecting members 720 may be folded or unfolded based on a movement of the second housing part 220. For example, when a distance between the first housing part 210 and the second housing part 220 increases, the one or more connecting members 720 may be at least partially unfolded, and when the distance decreases, the one or more connecting members 720 may be at least partially folded. The one or more connecting members 720 may include a flexible PCB (FPCB).

According to an embodiment, a third PCB 910 may be electrically connected to the first PCB 610. For example, a connector 911 of the third PCB 910 may be connected to the connector structure 830. The third PCB 910 may be electrically connected to the first PCB 610 through the connector structure 830 and the one or more connecting members 720.

According to an embodiment, a second PCB 620 may be electrically connected to the third PCB 910. For example, the second PCB 620 and the third PCB 910 may be electrically connected to each other via an electrical path 601. The electrical path 601 may extend from the second PCB 620 to the third PCB 910. An electrical signal may be transmitted between the second PCB 620 and the third PCB 910 via the electrical path 601. An electronic device 101 may further include another electrical path 602 opposite to the electrical path 601. For example, the electrical path 601 may be configured to transmit a first signal, and the other electrical path 602 may be configured to transmit a second signal different from the first signal. As the electrical path 601 for transmitting the first signal and the other electrical path 602 for transmitting the second signal are isolated, the first signal and the second signal may be electrically isolated. However, the electronic device 101 of the present disclosure is not limited thereto, and may include only one of the electrical paths 601 and 602.

Referring to FIG. 9B, a first housing part 210 may include sidewalls (or lateral sides). For example, the first housing part 210 may include a first sidewall 213 and a second sidewall 214 opposite to the first sidewall 213. The sidewalls of the first housing part 210 may be respectively coupled to a first guide member 930 and a second guide member 940, which are described below. The first sidewall 213 may be referred to as a first lateral side, and the second sidewall 214 may be referred to as a second lateral side.

According to an embodiment, a second housing part 220 may include a frame 630 and a slide cover 640. The frame 630 may accommodate electronic components included in the second housing part 220. For example, a battery (e.g., the battery 810 of FIG. 8), a driving mechanism 710, one or more connecting members 720, and a third PCB 910 may be accommodated in the frame 630. When a housing 201 is in a first state (e.g., a retracted state or a slide-in state), a second portion 232 of a flexible display 230 may surround a portion of the frame 630 and may be positioned between the slide cover 640 and the frame 630.

According to an embodiment, at least a portion of the flexible display 230 may be supported by a multi-bar track 820. When the flexible display 230 moves, the second portion 232 of the flexible display 230 may be configured to move along a side of the frame 630 facing a front side (e.g., a +z direction) of an electronic device 101, a side of the frame 630 facing a rear side (e.g., a -z direction) of the electronic device 101, and a side of the frame 630 facing a first direction (e.g., a -y direction). The multi-bar track 820 may be configured to move along the sides of the frame 630 together with the flexible display 230.

The electronic device 101 according to an embodiment may include guide members for guiding a movement of the second housing part 220 with respect to the first housing part 210. For example, the electronic device 101 may include a first guide member 930 and a second guide member 940 opposite to the first guide member 930.

For example, the first guide member 930 may include a first part 931 and a second part 934. The first part 931 may be coupled to a lateral side (e.g., a lateral side 631 of the frame 630) of the second housing part 220. The lateral side 631 may be perpendicular to a movement direction (e.g., a +y direction or the -y direction) of the second housing part 220. For example, the lateral side 631 of the second housing part 220 may be referred to as a lateral side of the frame 630 facing the -x direction. The first part 931 may include a guide rail 932 parallel to the movement direction (e.g., the y-axis direction) of the second housing part 220. The second part 934 may be movably coupled to the guide rail 932 of the first part 931 and may be coupled to an inner side of the first sidewall 213 of the first housing part 210 corresponding to the lateral side 631 of the second housing part 220 (e.g., the frame 630). As the second part 934 moves (e.g., slides) along the guide rail 932 of the first part 931 when the second housing part 220 moves by the driving mechanism 710, the first guide member 930 may be configured to guide the movement of the second housing part 220 with respect to the first housing part 210. For example, the lateral side 631 of the frame 630 may slide along the inner side of the first sidewall 213 of the first housing part 210, and a first lateral side 642 of the slide cover 640 coupled to the frame 630 may slide along an outer side of the first sidewall 213.

For example, the second guide member 940 may be substantially the same as the first guide member 930. For example, the second guide member 940 may include a third part 941 and a fourth part (not illustrated). The third part 941 may be coupled to a lateral side (e.g., a lateral side 632 of the frame 630) of the second housing part 220 opposite to the lateral side 631. The lateral side 632 may be perpendicular to the movement direction of the second housing part 220. For example, the lateral side of the second housing part 220 may be referred to as a lateral side of the frame 630 facing an +x direction. The third part 941 may include a guide rail (not illustrated) parallel to the movement direction (e.g., the y-axis direction) of the second housing part 220. The fourth part may be movably coupled to a guide rail of the third part 941 and may be coupled to an inner side of the second sidewall 214 of the first housing part 210 corresponding to the lateral side 632 of the second housing part 220 (e.g., the frame 630). When the second housing part 220 moves by the driving mechanism 710, as the fourth part moves (e.g., slides) along the guide rail of the third part 941, the second guide member 940 may be configured to guide the movement of the second housing part 220 with respect to the first housing part 210. Although not illustrated in FIG. 9B, the fourth part of the second guide member 940 may correspond to the second part 934 of the first guide member 930.

According to an embodiment, the slide cover 640 may be coupled to the frame 630 to surround at least a portion of the frame 630. The frame 630 and the slide cover 640 coupled to each other may move together. For example, the slide cover 640 may include the first lateral side 642 perpendicular to the movement direction (e.g., the y-axis direction) of the second housing part 220, a second lateral side 643 opposite to the first lateral side 642, and a third lateral side 644 facing the first direction (e.g., the -y direction). For example, a conductive portion 221 configured to function as an antenna radiator may define at least a portion of the third side 644, but the present disclosure is not limited thereto. When the second housing part 220 is coupled to the first housing part 210, the first lateral side 642 may cover a portion of the first sidewall 213 and a portion of the first guide member 930, and the second lateral side 643 may cover a portion of the second sidewall 214 and a portion of the second guide member 940.

According to an embodiment, a first PCB 610 may be included in the first housing part 210. The first PCB 610 may be electrically connected to a second PCB 620 disposed in the second housing part 220 through the one or more connecting members 720. In FIG. 9B, the first PCB 610 is illustrated as being included in the frame 630 of the second housing part 220, but this is merely for illustrating the first PCB 610 connected to the one or more connecting members 720 included in the frame 630 of the second housing part 220 in the exploded perspective view, and the first PCB 610 is disposed in the first housing part 210.

According to an embodiment, the second PCB 620 may be disposed on a rear side of the second housing part 220. For example, the second PCB 620 may be disposed on a rear side 641 of the slide cover 640 of the second housing part 220. The third PCB 910 may be disposed in the second housing part 220. For example, the third PCB 910 may be accommodated in the frame 630 of the second housing part 220. The second portion 232 of the flexible display 230 may be positioned between the second PCB 620 and the third PCB 910 when the housing 201 is in the first state (e.g., the retracted state or the slide-in state).

According to an embodiment, the second housing part 220 (e.g., the slide cover 640) may define a first through hole 645. The slide cover 640 defining the first through hole 645 may be referred to as the first through hole 645 that penetrates a portion of the slide cover 640 being included in the slide cover 640. For example, the first through hole 645 may be defined in at least one of the rear side 641, the first lateral side 642, or the second lateral side 643 of the slide cover 640. As illustrated in FIG. 9B, the first through hole 645 may be defined in the rear side 641 of the slide cover 640 on which the second PCB 620 is disposed, but the present disclosure is not limited thereto. Although not illustrated, the first through hole 645 may be defined in the first lateral side 642 or the second lateral side 643.

According to an embodiment, the first guide member 930 may define a second through hole 933. The first guide member 930 defining the second through hole 933 may be referred to as the second through hole 933 that penetrates a portion of the first guide member 930 being included in the first guide member 930. For example, the first part 931 of the first guide member 930 may define the second through hole 933. The first through hole 645 of the slide cover 640 and the second through hole 933 of the first guide member 930 may be aligned with each other. For example, the second through hole 933 may be aligned with the first through hole 645 with respect to the z-axis.

According to an embodiment, the second PCB 620 and the third PCB 910 may be electrically connected to each other at a space between the lateral side 631 of the frame 630 and the lateral side 642 of the slide cover 640 corresponding to the lateral side 631 of the frame 630. For example, the second PCB 620 and the third PCB 910 may be electrically connected to each other through the first through hole 645 and the second through hole 933. For example, an electrical path 601 that electrically connects the second PCB 620 and the third PCB 910 may extend from the second PCB 620, passing through the first through hole 645 and the second through hole 933, to the third PCB 910.

According to an embodiment, the electrical path 601 may include a first connector 922, a first flexible portion 921, a second connector 924, and/or a second flexible portion 923.

For example, the first connector 922 may be positioned at a location facing the second through hole 933 of the first guide member 930. For example, the first flexible portion 921 may extend from the first connector 922 to the second PCB 620 disposed on the rear side 641 of the slide cover 640. The first flexible portion 921 may be at least partially bent to pass through the first through hole 645 of the slide cover 640, and may extend from the second PCB 620 to a position facing the second through hole 933 of the first guide member 930. The first connector 922 may be positioned to face the second through hole 933 by being connected to an end of the first flexible portion 921 facing the second through hole 933 of the first guide member 930. The first flexible portion 921 and the first connector 922 may be referred to as a first flexible PCB (FPCB) portion. The first connector 922 and the first flexible portion 921 may be a portion of the second PCB 620.

For example, the second connector 924 may be connected to the first connector 922. The second flexible portion 923 may extend from the second connector 924 to the third PCB 910 accommodated in the frame 630. For example, the second flexible portion 923 extending from the third PCB 910 may pass through the second through hole 933 of the first guide member 930, and the second flexible portion 923 may be positioned to face the second through hole 933 of the first guide member 930. At least a portion of the second flexible portion 923 may be bent. The second connector 924 may be connected to an end of the second flexible portion 923 facing the second through hole 933 of the first guide member 930 and to the first connector 922. The second flexible portion 923 and the second connector 924 may be referred to as a second FPCB portion. The second connector 924 and the second flexible portion 923 may be a portion of the third PCB 910.

According to an embodiment, the electrical path 601 may electrically connect the second PCB 620 and the third PCB 910. As described above, the third PCB 910 may be electrically connected to the first PCB 610 through the one or more connecting members 720. Since the third PCB 910 is electrically connected to the second PCB 620 via the electrical path 601, the second PCB 620 may be electrically connected to the first PCB 610 through the third PCB 910.

According to an embodiment, the electrical path 601 may extend from the second PCB 620, across a lateral side 232a of the second portion 232 of the flexible display 230, to the third PCB 910. The lateral side 232a of the second portion 232 may be referred to as a lateral side of the second portion 232 perpendicular to the direction (e.g., the y-axis direction) in which the second housing part 220 moves. For example, the lateral side 232a may be referred to as a lateral side of the second portion 232 facing the -x direction. As described above, for a compact size, when the housing 201 is in the first state (e.g., the retracted state or the slide-in state), a rear plate 510 and the second portion 232 of the flexible display 230 may overlap with each other. Since the second portion 232 is positioned between the second PCB 620 and the third PCB 910 when the housing 201 is in the first state, a structure in which the electrical path 601 crosses the lateral side 232a of the second portion 232 of the flexible display 230 may not interfere with the second portion 232 and the rear plate 510. Since the second PCB 620 and the third PCB 910 may be electrically connected to each other via the electrical path 601, the second PCB 620 may be electrically connected to the first PCB 610.

Since the conductive portion 221 configured to function as an antenna radiator defines (or forms) at least a portion (e.g., the third lateral side 644) of lateral sides of the slide cover 640, the conductive portion 221 may be easily electrically connected to the second PCB 620 disposed on the rear side of the slide cover 640. As the second PCB 620 is connected to the first PCB 610 through the third PCB 910, the conductive portion 221 may be electrically connected to at least one processor (e.g., the processor 120 of FIG. 1) disposed on the first PCB 610. For example, the conductive portion 221 may be electrically connected to the at least one processor 120 via the second PCB 620, the electrical path 601, the third PCB 910, the one or more connecting members 720, and the first PCB 610. For example, RF signals transmitted to an external electronic device may be provided from the at least one processor 120 to the conductive portion 221 via the first PCB 610, the one or more connecting members 720, the third PCB 910, the electrical path 601, and the second PCB 620, and may be radiated to the external electronic device through the conductive portion 221. For example, RF signals received from the external electronic device may be received through the conductive portion 221, and may be provided to the at least one processor 120 via the second PCB 620, the electrical path 601, the third PCB 910, the one or more connecting members 720, and the first PCB 610.

The electronic device 101 according to an embodiment may include another electrical path 602. For example, a structure for the other electrical path 602 may substantially correspond to the structure for the electrical path 601 described above.

Referring to FIG. 9B and FIG. 9C, according to an embodiment, the second PCB 620 and the third PCB 910 may be electrically connected to each other at a space between the lateral side 631 of the frame 630 and the lateral side 642 of the slide cover 640 corresponding to the lateral side 631 of the frame 630. For example, the slide cover 640 may define a third through hole 646 for the other electrical path 602 to pass through. For example, the first through hole 645 may be adjacent to the first lateral side 642, and the third through hole 646 may be adjacent to the second lateral side 643. The second guide member 940 may define a fourth through hole 943. For example, the third part 941 of the second guide member 940 may define a fourth through hole (e.g., the fourth through hole 943 of FIG. 9B) for the other electrical path 602 to pass through.

According to an embodiment, the other electrical path 602 may extend from the second PCB 620, across another lateral side 232b of the second portion 232 of the flexible display 230, to the third PCB 910. For example, the other electrical path 602 may include a third connector 926, a third flexible portion 925, a fourth connector 928, and a fourth flexible portion 927. The third flexible portion 925 may extend from the second PCB 620, passing through the third through hole 646, to a position facing the fourth through hole 943 of the second guide member 940. The third connector 926 may be connected to an end of the third flexible portion 925 facing the fourth through hole 943 and may be positioned to face the fourth through hole 943. The third flexible portion 925 may be at least partially bent to pass through the third through hole 646 of the slide cover 640. For example, the fourth connector 928 may be connected to the third connector 926. The fourth flexible portion 927 may extend from the fourth connector 928 to the third PCB 910 accommodated in the frame 630. The fourth flexible portion 927 may pass through the fourth through hole 943 of the second guide member 940. The fourth flexible portion 927 passing through the fourth through hole 943 may be at least partially bent.

According to an embodiment, the electrical path 601 and the other electrical path 602 may provide isolation of signals. For example, first signals (e.g., baseband signals) may be transmitted via the electrical path 601, and second signals (e.g., RF signals) may be transmitted via the other electrical path 602. Since the electrical path 601 is positioned at a side (e.g., -x direction) of the electronic device 101, and the other electrical path 602 is positioned at another side (e.g., +x direction) of the electronic device 101, interference between the first signals and the second signals may be reduced. However, the electronic device 101 of the present disclosure is not limited thereto. The electronic device 101 may include only one of the electrical path 601 or the other electrical path 602.

According to an embodiment, the first sidewall 213 may cover a portion of the first guide member 930. A portion of the first guide member 930 defining the second through hole 933 may not be covered by the first sidewall 213. The second sidewall 214 may cover a portion of the second guide member 940. A portion of the second guide member 940 defining the fourth through hole 943 may not be covered by the second sidewall 214.

The second PCB 620, the third PCB 910, and the electrical path 601 described above may be referred to as signal line members in terms of transmitting an electrical signal. For example, the third PCB 910 may be referred to as a first line portion 910, the second PCB 620 may be referred to as a second line portion 620, and the electrical path 601 may be referred to as a third line portion 601. For example, the signal line member may include the first line portion 910 accommodated in the frame 630, the second line portion 620 disposed on the rear side of the slide cover 640, and the third line portion 601 connecting the first line portion 910 and the second line portion 620 and disposed to pass through the first through hole 645 and the second through hole 933. The third line portion 601 disposed to pass through the first through hole 645 and the second through hole 933 may include a FPCB portion. For example, the FPCB portion may include a first FPCB portion (e.g., the second flexible portion 923 and the second connector 924) connected to the first line portion 910, and a second FPCB portion (e.g., the first flexible portion 921 and the first connector 922) connected to the second line portion 620.

The electronic device 101 according to an embodiment may include an electrically conductive plate 970. The electrically conductive plate 970 may be positioned between the third PCB 910 and the second portion 232 of the flexible display 230 when the housing 201 is in the retracted state. The electrically conductive plate 970 may be configured to reduce electromagnetic interference between the second portion 232 of the flexible display 230 and electronic components (e.g., the driving mechanism 710 and/or the third PCB 910) disposed on the frame 630 when the housing 201 is in the retracted state. For example, the electrically conductive plate 970 may reduce electromagnetic interference between the second portion 232 of the flexible display 230 rolled into the housing 201 and the electronic components by being electrically connected to a ground of the electronic device 101, and may support the third PCB 910. For example, the electrically conductive plate 970 may be connected to the frame 630 of the second housing part 220 configured to function as a ground portion of the electronic device 101. Since the electrically conductive plate 970 is connected to the second housing part 220, when the second housing part 220 moves with respect to the first housing part 210, the electrically conductive plate 970 may move together with the frame 630 and the slide cover 640.

According to an embodiment, the second housing part 220 (e.g., the slide cover 640) may define openings. When the slide cover 640 is coupled to the frame 630 to cover the frame 630, the lateral sides (e.g., the first lateral side 642 and the second lateral side 643) of the slide cover 640 may cover the sidewalls (e.g., the first sidewall 213 and the second sidewall 214) of the first housing part 210 and the guide members (e.g., the first guide member 930 and the second guide member 940). A portion of the first guide member 930 and a portion of the second guide member 940 may be exposed to the outside of the slide cover 640 through the openings.

For example, a first opening 951 may be defined in the first lateral side 642 of the slide cover 640. Although not illustrated in FIGS. 9B and 9C, a second opening (not illustrated) may be defined in the second lateral side 643 of the slide cover 640 opposite to the first side 642. The first opening 951 and the second opening may be used for assembly of the electronic device 101.

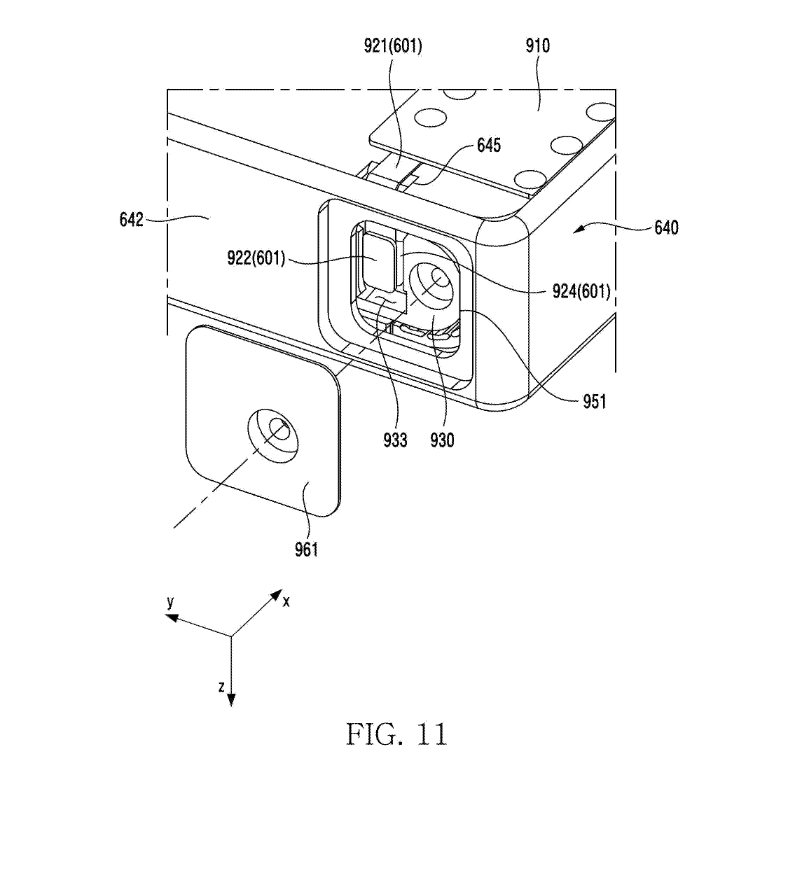

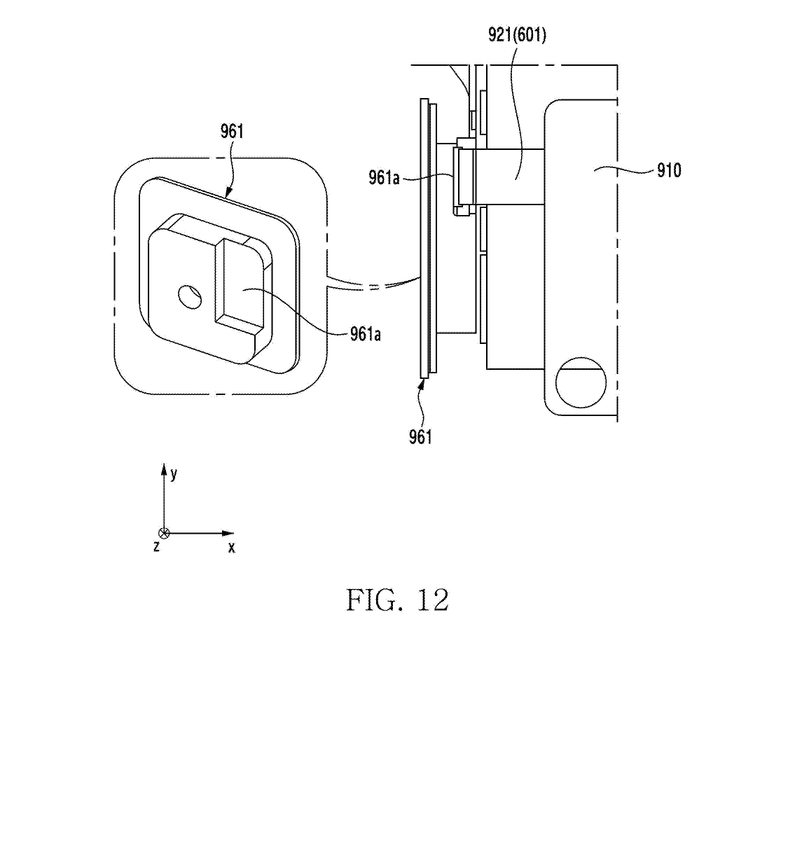

According to an embodiment, the slide cover 640 may include a first side plate 961 that covers the first opening 951 after the assembly of the electronic device 101 is completed. The first side plate 961 may be coupled to a portion of the first lateral side 642 of the slide cover 640 defining the first opening 951. The first opening 951 may be at least partially aligned with the second through hole 933 of the first guide member 930. The first side plate 961 that covers the first opening 951 may laterally support a portion of the electrical path 601. The electronic device 101 may include a second side plate 962 that covers the second opening. The second side plate 962 that covers the second opening may laterally support a portion of the other electrical path 602. A structure of the side plates will be described in greater detail below with reference to FIGS. 11 and 12.

In the disclosure, although the movement direction of the second housing part 220 with respect to the first housing part 210 is illustrated as corresponding to the y-axis direction with respect to the first housing part 210, the electronic device 101 of the disclosure is not limited thereto. For example, the movement direction of the second housing part 220 with respect to the first housing part 210 may correspond to the x-axis direction.

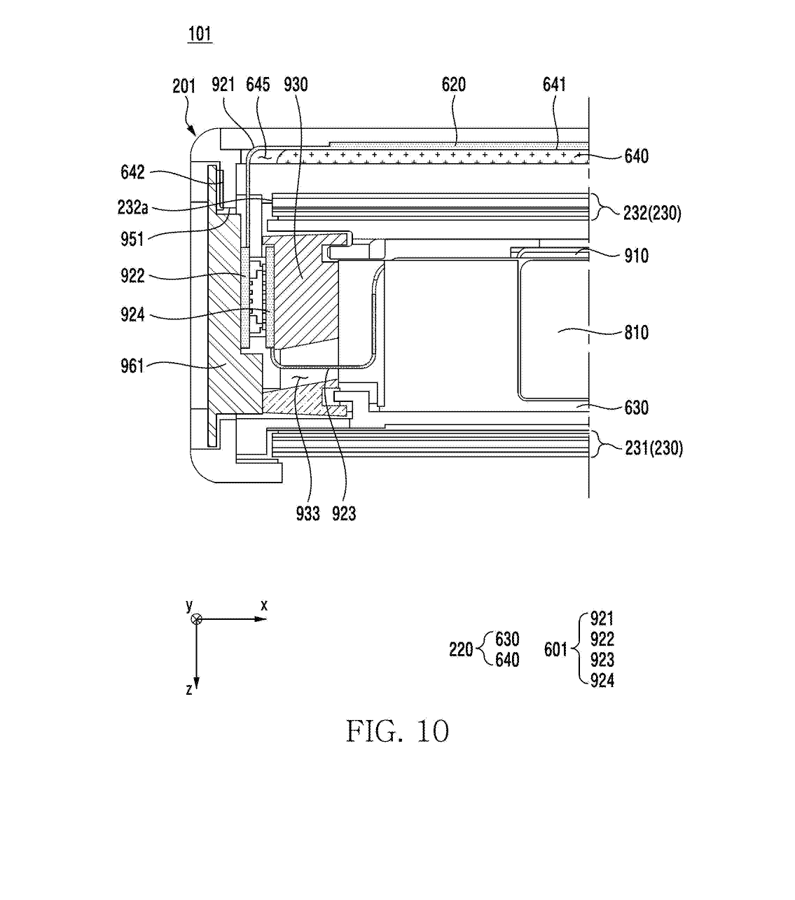

FIG. 10 is a cross-sectional view of a housing in a first state, taken along line B-B' of FIG. 6.

Referring to FIG. 10, a structure is described in which an electrical path 601 that electrically connects a second printed circuit board (PCB) 620 and a third PCB 910 passes through a first through hole 645 of a slide cover 640 of a second housing part 220 and a second through hole 933 of a first guide member 930, and extends across a lateral side 232a of a second portion 232 of a flexible display 230. Descriptions of the structure of the electrical path 601 illustrated in FIG. 10 may be substantially equally applied to another electrical path (e.g., the other electrical path 602 of FIG. 9C) extending across another lateral side (e.g., the other lateral side 232b of FIG. 9B) of the second portion 232.

Referring to FIG. 10, the second PCB 620 may be disposed on a rear side (e.g., a side facing a -z direction) of the slide cover 640 of the second housing part 220. The third PCB 910 may be accommodated in a frame 630 of the second housing part 220. For example, the third PCB 910 may at least partially overlap with a battery 810 accommodated in the frame 630. However, the present disclosure is not limited thereto, and the third PCB 910 may be spaced apart from the battery 810 so as not to overlap with the battery 810.

According to an embodiment, the electrical path 601 may extend from the second PCB 620, across the lateral side 232a of the second portion 232 of the flexible display 230, to the third PCB 910. The lateral side 232a of the second portion 232 may be perpendicular to a movement direction (e.g., a y-axis direction) of the second housing part 220. For example, the lateral side 232a may be referred to as a lateral side of the second portion 232 facing an -x direction. The first through hole 645 may be defined (or formed) in the second housing part 220 and the second through hole 933 may be defined (or formed) in the first guide member 930 such that the electrical path 601 may extend from the second PCB 620, across the lateral side 232a, to the third PCB 910.

According to an embodiment, the electrical path 601 may extend from the second PCB 620, passing through the first through hole 645 of the slide cover 640 of the second housing part 220 and the second through hole 933 of the first guide member 930, to the third PCB 910. For example, the electrical path 601 may include a first flexible portion 921, a first connector 922, a second flexible portion 923, and a second connector 924.

For example, an end of the first flexible portion 921 may be connected to the second PCB 620, and another end of the first flexible portion 921 may be positioned at a position facing the first through hole 645 of the slide cover 640. The first connector 922 may be connected to the other end of the first flexible portion 921 facing the first through hole 645.

For example, the second connector 924 may be connected to the first connector 922. An end of the second flexible portion 923 may be connected to the second connector 924, and another end of the second flexible portion 923 may be connected to the third PCB 910. The first flexible portion 921 passing through the first through hole 645 and the second flexible portion 923 passing through the second through hole 933 may be at least partially bent. In terms of the flexible portions being at least partially bent and transmitting electrical signals, the first flexible portion 921 and the first connector 922 may be referred to as a first flexible PCB (FPCB) portion, and the second flexible portion 923 and the second connector 924 may be referred to as a second FPCB portion.

According to an embodiment, the second PCB 620 may be electrically connected to a first PCB 610 through the third PCB 910 disposed in the second housing part 220. As described above, for a compact size, when a housing 201 is in the first state, the second portion 232 of the flexible display 230 and a rear plate (e.g., the rear plate 510 of FIG. 5) may overlap with each other. Since the rear plate 510 and the second portion 232 overlap with each other, it may be difficult to position a member for directly connecting the first PCB 610 and the second PCB 620 in the second housing part 220. Since the second PCB 620 is positioned behind (e.g., in the -z direction) the second portion 232, the electrical path 601 extending across the lateral side 232a of the second portion 232 may be disposed so as not to interfere with the second portion 232. The first through hole 645 of the slide cover 640 of the second housing part 220 and the second through hole 933 of the first guide member 930 may be defined such that the electrical path 601 extending across the lateral side 232a of the second portion 232 may be respectively connected to the second PCB 620 and the third PCB 910. The second PCB 620 may be electrically connected to the first PCB 610 through the structure.

According to an embodiment, a first opening 951 for assembly of an electronic device 101 may be defined at a first lateral side 642 of the slide cover 640. The first opening 951 may face the second through hole 933 of the first guide member 930. When a first side plate 961 is coupled to the first lateral side 642 to cover the first opening 951, the first side plate 961 may support a portion of the electrical path 601.

Hereinafter, a structure of the first side plate 961 supporting a portion of the electrical path 601 is described in greater detail.

FIG. 11 is a partial exploded perspective view of an electronic device. FIG. 12 illustrates an electrical path supported by a side plate.

Descriptions of a first side plate 961 and an electrical path 601 described with reference to FIGS. 11 and 12 may be substantially equally applied to a second side plate (e.g., the second side plate 962 of FIG. 9C) and another electrical path (e.g., the other electrical path 602 of FIG. 9C).

Referring to FIG. 11, a first opening 951 may be defined (or formed) at a first lateral side 642 of a slide cover 640 of a second housing part 220. The first lateral side 642 may be perpendicular to a movement direction (e.g., a y-axis direction) of the second housing part 220. A portion of a first guide member 930 may be exposed through the first opening 951 defined in the first lateral side 642.

According to an embodiment, the first opening 951 may face a second through hole 933 of the first guide member 930. For example, the first opening 951 may be at least partially aligned with the second through hole 933. As the first opening 951 is aligned with the second through hole 933, a portion of the electrical path 601 passing through a first through hole 645 and the second through hole 933 may be exposed through the first opening 951. For example, a portion of a first flexible portion 921, a first connector 922, and a second connector 924, which are positioned to face the second through hole 933 of the first guide member 930, may be exposed through the first opening 951.

According to an embodiment, the first side plate 961 may be coupled to the first lateral side 642 to cover the first opening 951. When the first side plate 961 is coupled to the first lateral side 642, a portion of the first side plate 961 may support a portion of the electrical path 601 by contacting the portion of the electrical path 601.

Referring to FIG. 12, the first side plate 961 may include a support portion 961a formed on an inner side facing the electrical path 601. The support portion 961a may be referred to as a recessed area. For example, the support portion 961a of the first side plate 961 may be in contact with a portion of the electrical path 601. The support portion 961a in contact with a portion of the electrical path 601 may support the portion of the electrical path 601 from a lateral side. The support portion 961a may have a shape corresponding to a shape of the electrical path 601 to support the electrical path 601. The portion of the electrical path 601 may maintain a stable shape by being in contact with the support portion 961a. For example, a portion of the first flexible portion 921, a first connector (e.g., the first connector 922 of FIG. 9B), and a second connector (e.g., the second connector 924 of FIG. 9B) may be supported by the support portion 961a. The first connector 922 and the second connector 924 supported by the first side plate 961 may maintain a stable connection.

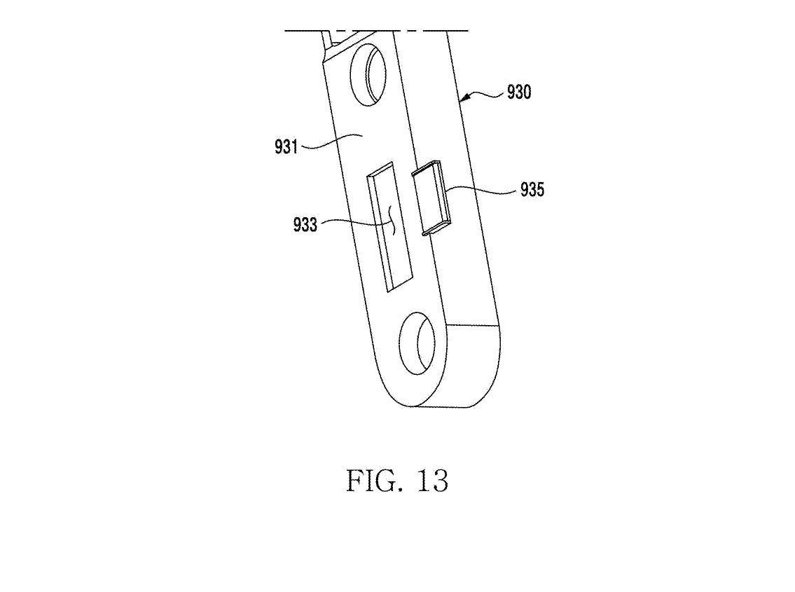

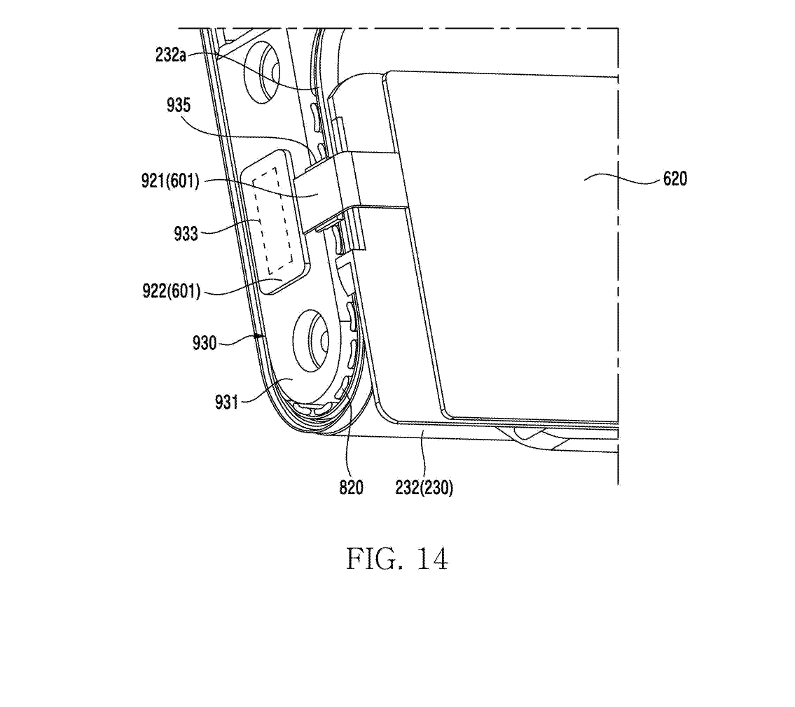

FIG. 13 is a partial perspective view illustrating a portion of a guide member. FIG. 14 illustrates an electrical path supported by a protruding portion of the guide member.

Descriptions of a protruding portion 935 of a first guide member 930 and an electrical path 601 described with reference to FIGS. 13 and 14 may be substantially equally applied to a second guide member (e.g., the second guide member 940 of FIG. 9B) and another electrical path (e.g., the other electrical path 602 of FIG. 9B).

Referring to FIG. 13, the first guide member 930 may include the protruding portion 935. For example, the protruding portion 935 may support a portion of an electrical path (e.g., the electrical path 601 of FIG. 14). Referring to FIG. 14, a portion of the electrical path 601 extending across a lateral side 232a of a second portion 232 of a flexible display 230 may be supported by the protruding portion 935. The protruding portion 935 may protrude toward a second printed circuit board (PCB) 620 to support a portion of the electrical path 601. For example, the protruding portion 935 may protrude from a first part 931 of the first guide member 930 toward the second PCB 620. For example, the protruding portion 935 may be adjacent to a second through hole 933. For example, the protruding portion 935 may be aligned with the second through hole 933.

According to an embodiment, as a portion of the electrical path 601 is supported by the protruding portion 935, it may not interfere with the second portion 232 of the flexible display 230 and a multi-bar track 820. For example, a first connector 922 of the electrical path 601 may be positioned to face the second through hole 933 of the first guide member 930. The protruding portion 935 may support a first flexible portion 921 extending from the second PCB 620 to the first connector 922.

Referring to FIG. 14, the protruding portion 935 may be positioned between the first flexible portion 921 of the electrical path 601 and the lateral side 232a of the second portion 232 of the flexible display 230. Since the first flexible portion 921 is disposed to cross over the lateral side 232a of the second portion 232, in a case in which the first flexible portion 921 is not supported, the first flexible portion 921 may be in contact with the second portion 232. When the second portion 232 moves, in a state in which the first flexible portion 921 is in contact with the second portion 232, the first flexible portion 921 may physically interfere with the second portion 232 and the multi-bar track 820. Since the protruding portion 935 of the first guide member 930 is positioned between the second portion 232 of the flexible display 230 and the first flexible portion 921, the electrical path 601 may not interfere with the second portion 232 and the multi-bar track 820. Since a portion (e.g., the first flexible portion 921) of the electrical path 601 may maintain a stable shape by being supported by the protruding portion 935, the electrical path 601 may not interfere with the second portion 232 and the multi-bar track 820.

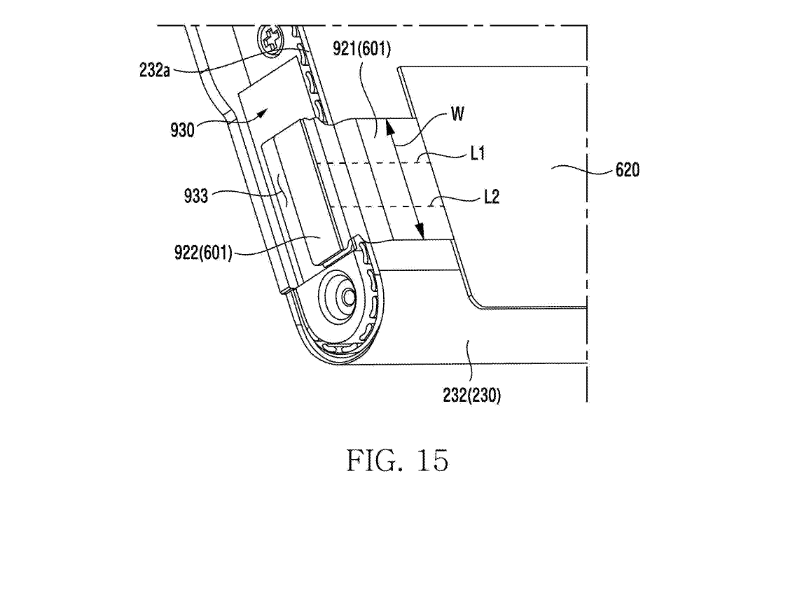

FIG. 15 illustrates signal lines included in an electrical path.

Referring to FIG. 15, signal lines may be included in an electrical path 601. For example, the electrical path 601 may include a first signal line L1 and a second signal line L2. First signals (e.g., baseband signals) may be transmitted through the first signal line L1, and second signals (e.g., RF signals) may be transmitted through the second signal line L2. For example, first signals delivered between a second printed circuit board (PCB) 620 and a third PCB 910 may be transmitted through the first signal line L1, and second signals delivered between the second PCB 620 and the third PCB 910 may be transmitted through the second signal line L2.

In a case in which the first signals and the second signals are transmitted through the electrical path 601, a width of the electrical path 601 may be wide for isolation between the first signals and the second signals. For example, a width of the electrical path 601 in an example where the first signals and the second signals are transmitted through the electrical path 601 may be wider than a width of the electrical path 601 in an example where the first signals are transmitted through the electrical path 601 and the second signals are transmitted through another electrical path (e.g., the other electrical path 602 of FIG. 9C). As illustrated in FIG. 15, in a case in which the electrical path 601 includes both the first signal line L1 and the second signal line L2, a width W of a first flexible portion 921 may be wide. In a case in which the width of the electrical path 601 is wide, isolation between the first signals and the second signals may be easy as a distance between the first signal line L1 and the second signal line L2 may be obtained. A width of a first connector 922 of the electrical path 601 and a width of a second through hole 933 of a first guide member 930 may increase corresponding to the increase of the width W of the first flexible portion 921. Although not illustrated in FIG. 15, in a case in which the first signal line L1 and the second signal line L2 are included in the electrical path 601, an electronic device 101 may not include the other electrical path 602.

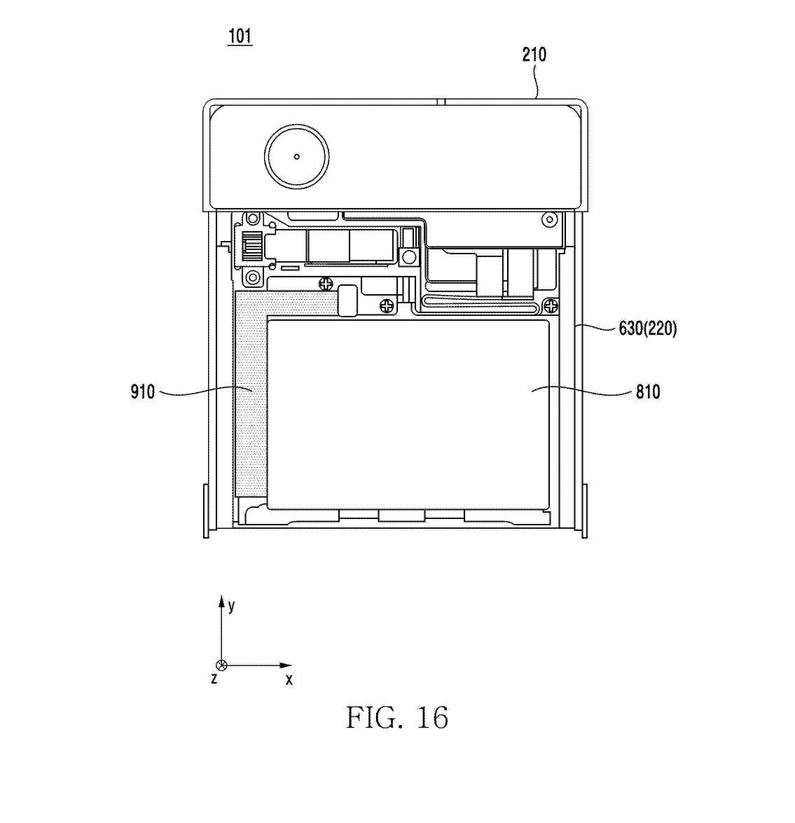

FIG. 16 illustrates an electronic device including a third printed circuit board (PCB) spaced apart from a battery.

Referring to FIG. 16, a battery 810 and a third PCB 910 may be accommodated in a frame 630 of a second housing part 220. As described above, the third PCB 910 may at least partially overlap with the battery 810, but is not limited thereto. As illustrated in FIG. 16, the battery 810 and the third PCB 910 accommodated in the frame 630 may be disposed so as not to overlap with each other. For example, the third PCB 910 may be spaced apart from the battery 810. For example, the battery 810 may have a rectangular parallelepiped shape, and the third PCB 910 may have an L-shape so as to be disposed along a portion of edges of the battery 810.

For example, according to the number of electronic components included in an electronic device 101, an arrangement structure, and a size of the second housing part 220, the battery 810 and the third PCB 910 may be disposed so as not to overlap with each other. In a case in which the third PCB 910 is spaced apart from the battery 810, the battery 810 and the third PCB 910 may be disposed on substantially the same plane, thereby reducing a thickness of the electronic device 101 (e.g., thickness in a z-axis direction).

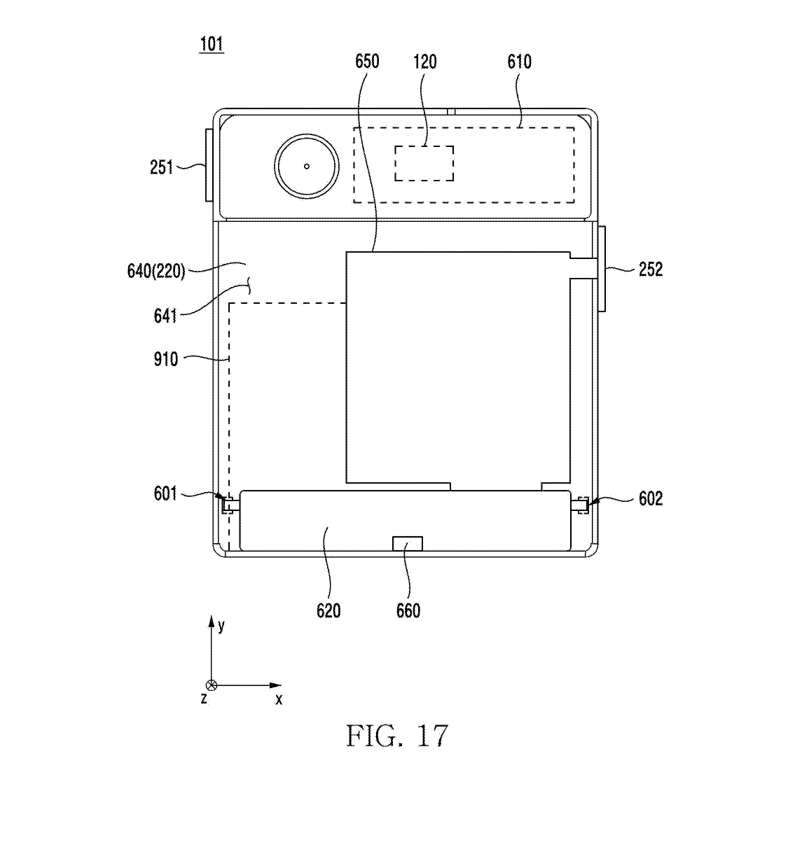

FIG. 17 illustrates one or more electronic components electrically connected to a second printed circuit board (PCB).

Referring to FIG. 17, an electronic device 101 may include one or more electronic components electrically connected to a second PCB 620. For example, the one or more electronic components electrically connected to the second PCB 620 may include at least one of an inductive coil 650 for wireless charging or short-range wireless communication (SRC), a microphone 660 electrically connected to the second PCB 620, or a second key button 252 for receiving a user input.

According to an embodiment, the inductive coil 650 may be disposed on a rear side of a slide cover 640 of a second housing part 220. For example, the inductive coil 650 may be used for short-range wireless communication (SRC) with an external electronic device. The inductive coil 650 may include a near field communication (NFC) antenna configured to transmit and/or receive data when in proximity to an antenna of an external electronic device. For example, the inductive coil 650 may include a wireless power communication (WPC) antenna configured to wirelessly receive power from a wireless charging device. For example, the inductive coil 650 may include a magnetic secure transmission (MST) antenna configured to wirelessly transmit and/or receive payment information. Since the inductive coil 650 should be in proximity to an external device (e.g., an external electronic device, a wireless charging device, or a payment terminal) for short-range wireless communication (SRC), it may be disposed on the rear side of the slide cover 640. A signal, power, or data received through the inductive coil 650 may be provided to the second PCB 620 electrically connected to the inductive coil 650.

According to an embodiment, the microphone 660 may be configured to convert sound around the electronic device 101 into an electrical signal. For example, the microphone 660 may be used to record sound around the electronic device 101 or to convert a voice of a user into an electrical signal. The electrical signal generated by the microphone 660 may be provided to the second PCB 620.

According to an embodiment, the second key button 252 may be configured to receive a user input. For example, the second key button 252 may be used to receive a user input related to power of the electronic device 101, a user input related to volume adjustment of a speaker (e.g., the acoustic output module 155 of FIG. 1) of the electronic device 101, or a user input related to a movement of the second housing part 220. When the second key button 252 is pressed by a user, the second key button 252 may generate an electrical signal corresponding to the user input. The electrical signal generated by the second key button 252 may be provided to the second PCB 620.

The one or more electronic components may be electrically connected to the second PCB 620 since the one or more electronic components are difficult to be electrically connected to a third PCB 910 disposed inside the second housing part 220. Since at least one processor 120 is disposed on a first PCB 610 disposed in a first housing part 210, an electrical connection between the second PCB 620 and the first PCB 610 may be required to electrically connect the one or more electronic components to the at least one processor 120. As described above, the second PCB 620 may be electrically connected to the third PCB 910 disposed in the second housing part 220 via an electrical path 601 and/or another electrical path 602. The one or more electronic components electrically connected to the second PCB 620 may be electrically connected to the at least one processor 120 via the electrical path 601 (or the other electrical path 602), the third PCB 910, and the first PCB 610. Since the second PCB 620 is electrically connected to the first PCB 610 through the third PCB 910, the design flexibility of the second PCB 620 may be improved.

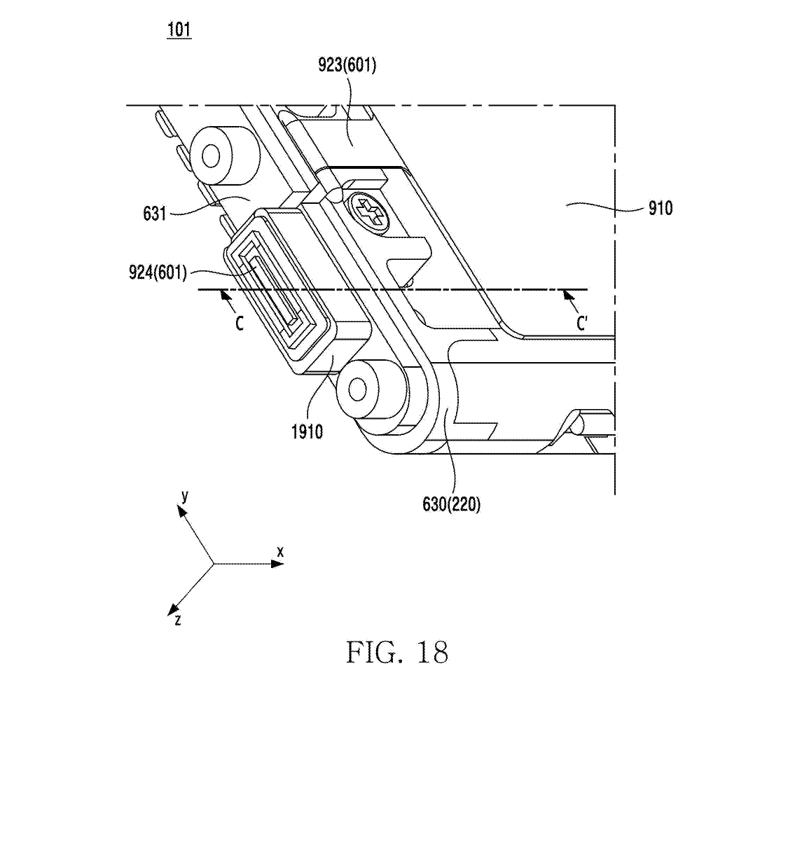

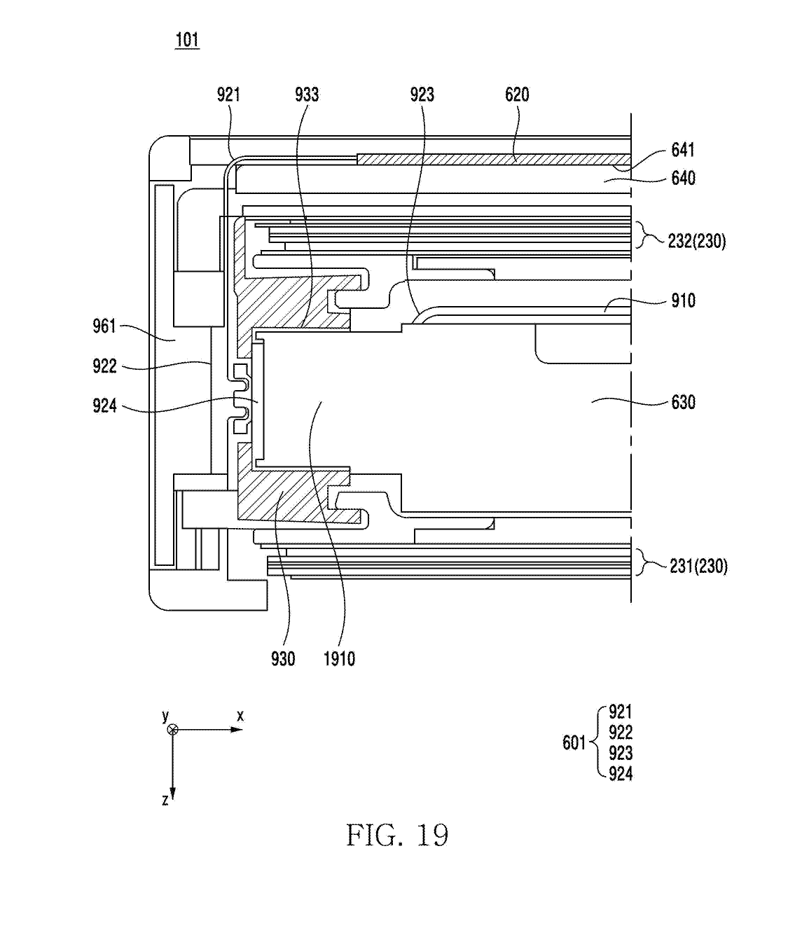

FIG. 18 illustrates a seating structure of a second housing part for fixing an electrical path. FIG. 19 is a cross-sectional view of the electronic device of FIG. 18, taken along line C-C'.

Descriptions of a seating structure of a second housing part 220 for an electrical path 601, described with reference to FIGS. 18 and 19, may be substantially equally applied to another electrical path (e.g., the other electrical path 602 of FIG. 9C).

Referring to FIG. 18, the second housing part 220 may include a seating structure 1910 for fixing the electrical path 601. For example, the seating structure 1910 for fixing and supporting a second connector 924 of the electrical path 601 may be formed at a lateral side 631 of a frame 630. The second connector 924 of the electrical path 601 may stably maintain its position by being fixed and supported by the seating structure 1910. The seating structure 1910 may protrude in a direction (e.g., an -x direction) in which the second connector 924 faces, from the lateral side 631 of the frame 630. A second flexible portion 923 of the electrical path 601 may be inserted into the frame 630, and may extend from a third printed circuit board (PCB) 910 accommodated in the frame 630 to the seating structure 1910 of the frame 630.

Referring to FIG. 19, the frame 630 may include the seating structure 1910. The seating structure 1910 may be inserted into a second through hole 933 of a first guide member 930. The second connector 924 may be fixed and supported by the seating structure 1910. The second flexible portion 923 of the electrical path 601 may extend from the third PCB 910 accommodated in the frame 630 to the second connector 924. A first flexible portion 921 may extend from a second PCB 620 disposed on a rear side of a slide cover 640 to a first connector 922 connected to the second connector 924.

According to an embodiment, as a portion (e.g., the second connector 924) of the electrical path 601 inserted into the second through hole 933 of the first guide member 930 may be supported and fixed by the seating structure 1910 of the frame 630, an electrical connection between the second PCB 620 and the third PCB 910 by the electrical path 601 may be stably provided.

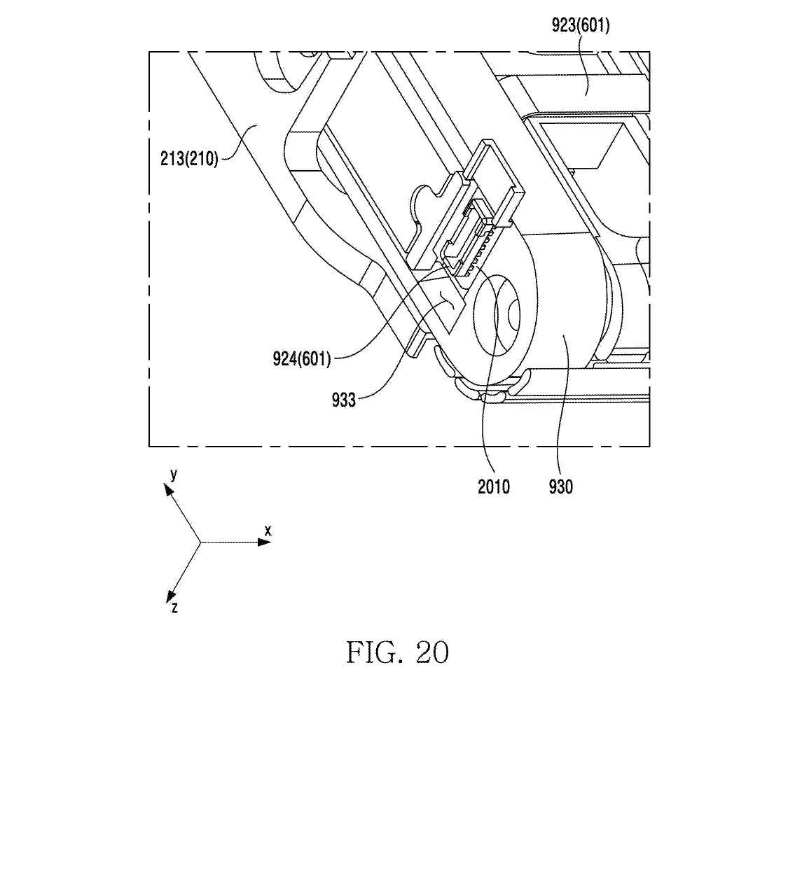

FIG. 20 illustrates a seating structure of a guide member for fixing an electrical path.

Descriptions of a seating structure of a first guide member 930 and an electrical path 601 described with reference to FIG. 20 may be substantially equally applied to a second guide member (e.g., the second guide member 940 of FIG. 9C) and another electrical path (e.g., the other electrical path 602 of FIG. 9C).

Referring to FIG. 20, the first guide member 930 may include a seating structure 2010 for fixing the electrical path 601. For example, the seating structure 2010 for fixing and supporting a second connector 924 of the electrical path 601 may be formed at the first guide member 930. The second connector 924 of the electrical path 601 may stably maintain its position by being fixed and supported by the seating structure 2010. The seating structure 2010 of the first guide member 930 may be disposed in a second through hole 933 for a portion of the electrical path 601. The second connector 924 may be inserted into the seating structure 2010 in the second through hole 933 and may be fixed and supported. A second flexible portion 923 of the electrical path 601 may extend from a third printed circuit board (PCB) (e.g., the third PCB 910 of FIG. 9B) accommodated in a frame 630 to the seating structure 2010 of the first guide member 930.

According to an embodiment, as a portion (e.g., the second connector 924) of the electrical path 601 may be supported and fixed by the seating structure 2010 of the first guide member 930, an electrical connection between a second PCB 620 and the third PCB 910 by the electrical path 601 may be stably provided.

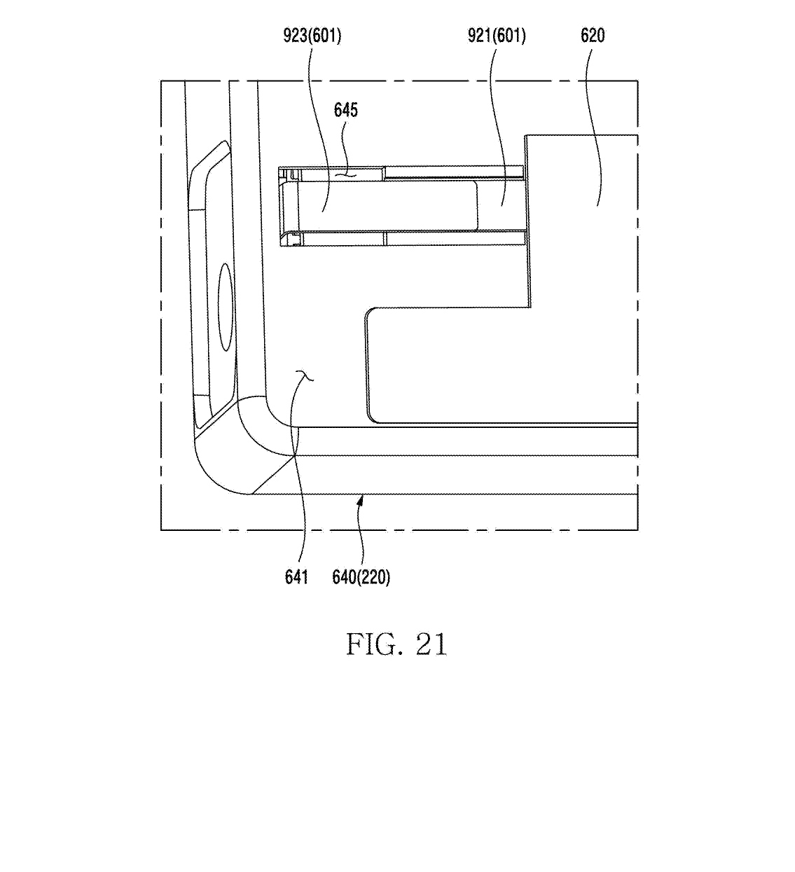

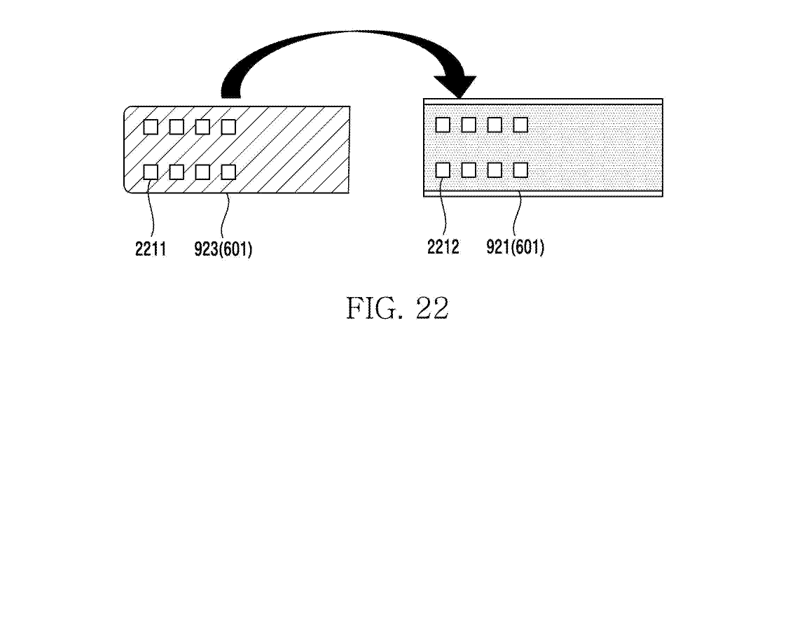

FIG. 21 illustrates an electrical path connected to a second printed circuit board (PCB). FIG. 22 illustrates a soldering structure of flexible portions.

Referring to FIG. 21, portions of an electrical path 601 that electrically connects a second PCB 620 and a third PCB (e.g., the third PCB 910 of FIG. 9B) may be joined by soldering. For example, the electrical path 601 may include a first flexible portion 921 connected to the second PCB 620 and a second flexible portion 923 connected to the third PCB 910. Unlike the examples described above, the electrical path 601 may not include connectors (e.g., the first connector 922 and the second connector 924 of FIG. 9C). In a case in which connectors of the electrical path 601 are omitted, the first flexible portion 921 and the second flexible portion 923 may be directly connected to each other. For example, the first flexible portion 921 may be positioned on a rear side of a slide cover 640 of a second housing part 220. The second flexible portion 923 may extend from the third PCB 910 in the second housing part 220, passing through a second through hole 933 of a first guide member 930 and a first through hole 645 of the slide cover 640, to the first flexible portion 921. The second flexible portion 923 may be soldered to the first flexible portion 921. As the first flexible portion 921 and the second flexible portion 923 are soldered to each other, the third PCB 910 may be electrically connected to the second PCB 620.

Referring to FIG. 22, a first flexible portion 921 and a second flexible portion 923 may be connected to each other through hot bar soldering. For example, first solders 2212 may be disposed on an outer side of the first flexible portion 921, and second solders 2211 may be disposed on an inner side of the second flexible portion 923. When the inner side of the second flexible portion 923 be in contact with the outer side of the first flexible portion 921, each of the second solders 2211 may be in contact with each of the first solders 2212. In a state in which the first solders 2212 and the second solders 2211 are in contact with each other, the first solders 2212 and the second solders 2211 may be heated and pressurized. Due to heat and pressure, the first solders 2212 and the second solders 2211 may be melted. As the first solders 2212 and the second solders 2211 that are melted solidify again, the first solders 2212 and the second solders 2211 may be joined to each other. As the first flexible portion 921 and the second flexible portion 923 are soldered, a third printed circuit board (PCB) 910 may be electrically connected to a second PCB 620. In this case, connectors of an electrical path 601 may be omitted. In addition, a connection structure of portions of the electrical path 601 may be implemented in various ways.

The technical problems addressed by the present disclosure are not limited to those described above, and other technical problems not mentioned herein will be clearly understood by those of ordinary skill in the art to which the present disclosure belongs.

An electronic device 101 is disclosed. The electronic device 101 may comprise a housing 201. The housing 201 may include a first housing part 210 and a second housing part 220 configured to movably engage with the first housing part 210 to provide a retracted state of the housing 201 and an extended state of the housing 201. The second housing part 220 may include a frame 630 that accommodates a battery 810, and a slide cover 640 that at least partially surrounds the frame 630 to accommodate the frame 630. The electronic device 101 may comprise a flexible display 230 disposed at the first housing part 210 and the second housing part 220 such that a size of an area of the flexible display 230 that is visible from a front side of the housing 201 changes as a state of the housing 201 is changed between the retracted state and the extended state. The flexible display 230 may include a first portion 231 visible(or exposed) to the front side of the housing 201 when the housing 201 is in the retracted state, and a second portion 232 that is not visible(or exposed) to the front side and is at least partially positioned at a space between the frame 630 and the slide cover 640. The electronic device 101 may comprise a first printed circuit board (PCB) 610 disposed at the first housing part 210. The electronic device 101 may comprise a second PCB 620 disposed at the slide cover 640. The electronic device 101 may comprise a third PCB 910 disposed at the frame 630. The second PCB 620 may be electrically connected to the first PCB 610 through the third PCB 910. The second PCB 620 and the third PCB 910 may be electrically connected to each other at a space between a lateral side 631 of the frame 630 and a lateral side 642 of the slide cover corresponding to the lateral side 631 of the frame 630. The first PCB 610 and the third PCB 910 may be electrically connected to each other through a connecting member 720 that includes a flexible portion that is at least partially deformed in response to a movement of the second housing part 220 with respect to the first housing part 210. When the state of the housing 201 is changed from the extended state to the retracted state, the second portion 231 of the flexible display 230 may be inserted into a space between the second PCB 620 and the third PCB 910.

An electronic device 101 is disclosed. The electronic device 101 may comprise a housing 201. The housing 201 may include a first housing part 210 and a second housing part 220 configured to movably engage with the first housing part 210 to provide a retracted state of the housing 201 and an extended state of the housing 201. The second housing part 220 may include a conductive portion 221 configured to function as an antenna radiator. The electronic device 101 may comprise a flexible display 230 coupled to the first housing part 210 and the second housing part 220 such that a size of an area of the flexible display 230 that is visible from a front side of the housing 201 changes as a state of the housing 201 is changed between the retracted state and the extended state. The flexible display 230 may include a portion 232 positioned within the housing 201 when the housing 201 is in the retracted state. The electronic device 101 may comprise a first printed circuit board (PCB) 610 disposed in the first housing part 210. At least one processor 120 comprising processing circuitry may be disposed on the first PCB 610. The electronic device 101 may comprise a second PCB 620, disposed in the second housing part 220 to be positioned behind the portion 232 of the flexible display 230 when the housing 201 is in the retracted state, and electrically connected to the conductive portion 221 of the second housing part 220. The electronic device 101 may comprise a third PCB 910 disposed in the second housing part 220 and electrically connected to the first PCB 610. The portion 232 of the flexible display 230 may be positioned between the second PCB 620 and the third PCB 910 when the housing 201 is in the retracted state. The electronic device 101 may comprise an electrical path 601 extending from the second PCB 620, across a lateral side 232a of the portion 232 of the flexible display 230 perpendicular to a direction in which the second housing part 220 moves when the state of the housing 201 is changed, to the third PCB 910. The third PCB 910 may be electrically connected to the second PCB 620 via the electrical path 601.

According to an example embodiment, the conductive portion 221 of the second housing part 220 may be electrically connected to the at least one processor 120 via the second PCB 620, the electrical path 601, the third PCB 910, and the first PCB 610.

According to an example embodiment, the first housing part 210 may include a rear plate 510 defining a portion of a rear side of the first housing part 210 positioned outside the second housing part 220 when the housing 201 is in the extended state. The portion 232 of the flexible display 230 may at least partially overlap the rear plate 510 when the housing 201 is in the retracted state.

According to an example embodiment, the second PCB 620 may be disposed on a rear side 641 of the second housing part 220. The second housing part 220 may define a first through hole 645 at the rear side of the second housing part 220. The electronic device 101 may further comprise a guide member 930 configured to guide a movement of the second housing part 220 with respect to the first housing part 210, defining a second through hole 933. The electrical path 601 may pass through the first through hole 645 of the second housing part 220 and the second through hole 933 of the guide member 930 to extend from the second PCB 620 to the third PCB 910.

For example, the electrical path 601 may include a first connector 922 positioned to face the second through hole 933 of the guide member 930. The electrical path 601 may include a first flexible portion 921 extending from the first connector 922 to the second PCB 620, and at least partially bent to pass through the first through hole 645 of the second housing part 220. The electrical path 601 may include a second connector 924 connected to the first connector 922. The electrical path 601 may include a second flexible portion 923 extending from the second connector 924 to the third PCB 910, and at least partially bent to pass through the second through hole 933 of the guide member 930.

According to an example embodiment, the guide member 930 may include a protruding portion 935 that protrudes toward the second PCB 620 disposed on the rear side of the second housing part 220 to support a portion of the electrical path 601 positioned within the second housing part 220.

According to an example embodiment, the protruding portion 935 of the guide member 930 may be positioned between the portion 232 of the flexible display 230 and the portion of the electrical path 601. Physical interference between the portion 232 and the electrical path 601 may be reduced by the protruding portion 935.

According to an example embodiment, the guide member 930 may include a first part 931 including a guide rail 932, defining the second through hole 933, and coupled to a lateral side 631 of the second housing part 220 perpendicular to the direction, and a second part 934 movably coupled to the guide rail 932 of the first part 931 and coupled to a lateral side (e.g., a first sidewall 213) of the first housing part 210 corresponding to the lateral side 631 of the second housing part 220.

According to an example embodiment, the electronic device 101 may further include another electrical path 602 extending from the second PCB 620, across another lateral side 232b of the portion 232 of the flexible display 230, which is opposite to the lateral side 232a of the portion 232 of the flexible display 230, to the third PCB 910.

For example, baseband signals provided from the at least one processor 120 to one or more electronic components electrically connected to the second PCB 620 may be transmitted via the electrical path 601. RF signals provided from the conductive portion 221 of the second housing part 220 to the at least one processor 120 may be transmitted via the other electrical path 602. As signals transmitted via the electrical path 601 and the other electrical path 602 are isolated from each other, electromagnetic interference between a first signal and a second signal may be reduced.

According to an example embodiment, the second housing part 220 may define an opening 951 at a lateral side 642 of the second housing part 220 perpendicular to the direction, and the opening 951 may overlap with a portion of the electrical path 601. The electronic device 101 may further comprise a side plate 961 coupled to the lateral side 642 of the second housing part 220 to cover the opening 951, supporting the portion of the electrical path 601.

According to an example embodiment, the electronic device 101 may further comprise one or more flexible connecting members 720 that electrically connect the first PCB 610 and the third PCB 910. The one or more connecting members 720 may be at least partially bent or unfolded in response to the movement of the second housing part 220.

According to an example embodiment, the electronic device 101 may further comprise one or more electronic components disposed in the second housing part 220 and electrically connected to the second PCB 620. The at least one processor 120 may be electrically connected to the one or more electronic components via the first PCB 610, the third PCB 910, the electrical path 601, and the second PCB 620.

According to an example embodiment, the one or more electronic components may include at least one of an inductive coil 650 for wireless charging or short-range wireless communication (SRC), a microphone 660, or a key button 252 for receiving a user input.

According to an example embodiment, the electronic device 101 may further comprise an electrically conductive plate 970 positioned between the third PCB 910 and the portion 232 of the flexible display 230 when the housing 201 is in the retracted state. The electrically conductive plate 970 may be electrically connected to a portion of the second housing part 220 configured to function as a ground portion of the electronic device 101. The electrically conductive plate 970 may reduce electromagnetic interference between the rear plate 510 and the portion 232 of the flexible display 230, which overlap for a compact size. The electrically conductive plate 970 may reduce electromagnetic interference between the third PCB 910 and the portion 232 of the flexible display 230.

According to an example embodiment, the slide cover 640 may include a rear cover 312 covering a rear side 641 of the slide cover 640 to cover the second PCB 620.

An electronic device 101 is disclosed. The electronic device 101 may comprise a housing 201. The housing 201 may include a first housing part 210 including a sidewall 213, and a second housing part 220 configured to movably connect to the first housing part 210. The second housing part 220 may include a frame 630 accommodating a battery 810, and a slide cover 640 connected to the frame 630, at least partially surrounding the frame 630, and defining a first through hole 645. The electronic device 101 may comprise a flexible display 230 coupled to the first housing part 210 and the second housing part 220. The electronic device 101 may comprise a guide member 930 configured to guide a movement of the second housing part 220 with respect to the first housing part 210 by being connected to the sidewall 213 of the first housing part 210 and a lateral side 631 of the frame 630. The guide member 930 may define a second through hole 933. The electronic device 101 may comprise a first printed circuit board (PCB) 610 disposed at the first housing part 210. The electronic device 101 may comprise a second PCB 620 disposed at the slide cover 640 of the second housing part 220. The electronic device 101 may comprise a third PCB 910 disposed at the frame 630 of the second housing part 220. A signal of the third PCB 910 may be delivered to the first PCB 610 through the second PCB 620. The second PCB 620 and the third PCB 910 may be electrically connected to each other through the first through hole 645 and the second through hole 933.

According to an example embodiment, the electronic device 101 may further comprise one or more connecting members 720 disposed at the frame 630 of the second housing part 220 and electrically connecting the first PCB 610 and the third PCB 910.

According to an example embodiment, the electronic device 101 may further comprise at least one processor 120 comprising processing circuitry and disposed on the first PCB 610. The slide cover 640 of the second housing part 220 may include a conductive portion 221 electrically connected to the second PCB 620. The at least one processor 120 may be electrically connected to the conductive portion 221 of the slide cover 640 through the first PCB 610, the second PCB 620, and the third PCB 910. For example, the conductive portion 221 may be configured to function as an antenna radiator.

According to an example embodiment, the flexible display 230 may include a first portion 231 visible from the front side of the housing 201, and a second portion 232 positioned within the housing 201 when the housing 201 is in the retracted state. The first housing part 210 may include a rear plate 510. The rear plate 510 of the first housing part 210 may overlap at least a portion of the second portion 232 of the flexible display 230 when the housing 201 is in the retracted state.

According to an example embodiment, the electronic device 101 may further comprise an electrical path 601 extending from the second PCB 620 to the third PCB 910 to electrically connect the second PCB 620 and the third PCB 910. The electrical path 601 may pass through the first through hole 645 of the slide cover 640 and the second through hole 933 of the guide member 930.

An electronic device 101 is disclosed. The electronic device 101 may comprise a housing 201 including a first housing part 210 and a second housing part 220. The second housing part 220 may include a conductive portion 221 and may be configured to slide-in and slide-out with respect to the first housing part 210. The electronic device 101 may comprise a display 230 accommodated in the housing 201 such that a size of a display area visible from the outside of the electronic device 101 changes as the second housing part 220 slides-in or slides-out with respect to the first housing part 210. The electronic device 101 may comprise a printed circuit board (PCB) 610 accommodated in the first housing part 210, wherein a processor 120 is disposed thereon. The electronic device 101 may include a sliding module configured to support the slide-in and slide-out of the second housing part 220 with respect to the first housing part 210. The sliding module may include a frame 630, a first guide member 930 and a second guide member 940 respectively disposed at a first side and a second side opposite to each other of the frame 630, the first guide member 930 including a first through hole (e.g., the second through hole 933 of FIG. 9B) formed therein, a multi-bar track 820 configured to move along an upper side or a lower side of the frame 630, guided by the first guide member 930 and the second guide member 940, and a slide cover 640 at least substantially covering the frame 630, the first guide member 930, and the second guide member 940. The slide cover 640 may include a second through hole (e.g., the first through hole 645 of FIG. 9B) formed in a first sidewall 642 facing the first guide member 930 or in an upper side 641 facing the frame 630. The electronic device 101 may include a signal line member electrically connecting the conductive portion 221 of the second housing part 220 and the processor 120. The signal line member may include a first line portion 910 disposed at the upper side of the frame 630, a second line portion 620 disposed at the upper side 641 of the slide cover 640, and a third line portion 601 connecting the first line portion 910 and the second line portion 620 and disposed to pass through the first through hole 933 and the second through hole 645.

According to an example embodiment, the third line portion 601 may include a flexible PCB (FPCB) portion. For example, the third line portion 601 may have flexibility to be at least partially bendable.

According to an example embodiment, the FPCB portion may include a first FPCB portion connected to the first line portion 910, and a second FPCB portion connected to the second line portion 620.

According to an example embodiment, the electronic device 101 may further comprise a battery 810. The PCB portion may be disposed not to overlap the battery 810 when viewed from above.

According to an example embodiment, the second line portion 620 may include a PCB portion.

According to an example embodiment, the PCB portion may substantially extend along a length of the conductive portion 221 of the second housing part 220.

According to an example embodiment, the first guide member 930 may include a protruding portion 935 that protrudes in a direction substantially perpendicular to its length direction and is formed adjacent to the first through hole 933. The third line portion 601 may at least partially overlap the protruding portion 935.

According to an example embodiment, the second guide member 940 may include a third through hole 943 formed therein. The slide cover 640 may include a fourth through hole 646 formed in a second sidewall 643 facing the second guide member 940 or in the upper surface 641 facing the frame 630. The signal line member may include a fourth line portion 602 connecting the first line portion 910 and the second line portion 620 and disposed to pass through the third through hole 943 and the fourth through hole 646.

According to an example embodiment, the third line portion 601 may be configured to communicate a first signal with the processor. The fourth line portion may be configured to communicate a second signal different from the first signal with the processor.

According to an example embodiment, the slide cover 640 may include a side plate 961 covering an opening 951 formed at the first sidewall 642 to at least partially overlap the first through hole 933.

According to an example embodiment, an inner side of a sidewall of the side plate 961 may include a recessed area 961a formed to at least partially overlap the third line portion 601.

According to an embodiment, the processor 120 may form at least a portion of a communication processor. The conductive portion 221 may form at least a portion of an antenna.

The effects that can be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), the element may be coupled with the other element directly (e.g., wiredly), wirelessly, or via a third element.

As used in connection with various embodiments of the disclosure, the term "module" may include a unit implemented in hardware, software, firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the "non-transitory" simply means that the storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for" or "means.”

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a housing including:
a first housing part, and
a second housing part configured to movably engage with the first housing part to provide a retracted state of the housing and an extended state of the housing, the second housing part including:
a frame configured to accommodate a battery, and
a slide cover at least partially surrounding the frame to accommodate the frame;
a flexible display disposed at the first housing part and the second housing part such that a size of an area visible from a front side of the housing changes as a state of the housing is changed between the retracted state and the extended state, the flexible display including:
a first portion visible to the front side of the housing, based on the housing being in the retracted state, and
a second portion, not visible to the front side, at least partially positioned between the frame and the slide cover;
a first printed circuit board (PCB) disposed at the first housing part;
a second PCB disposed at the slide cover; and
a third PCB disposed at the frame,
wherein the second PCB is electrically connected to the first PCB through the third PCB,
wherein the second PCB and the third PCB are electrically connected to each other at a space between a lateral side of the frame and a lateral side of the slide cover corresponding to the lateral side of the frame,
wherein the first PCB and the third PCB are electrically connected to each other through a connecting member, the connecting member including a flexible portion at least partially deformable in response to a movement of the second housing part with respect to the first housing part, and
wherein the second portion of the flexible display is configured to be inserted into a space between the second PCB and the third PCB, based on the state of the housing being changed from the extended state to the retracted state.

2. The electronic device of claim 1, further comprising an electrical path extending from the second PCB, across a lateral side of the second portion of the flexible display perpendicular to a direction in which the second housing part moves, based on the state of the housing being changed, to the third PCB, and
wherein the third PCB is electrically connected to the second PCB through the electrical path.

3. The electronic device of claim 1, further comprising at least one processor, comprising processing circuitry, mounted on the first PCB,
wherein the second housing part includes a conductive portion configured to function as an antenna radiator, and
wherein the conductive portion of the second hosing part is electrically connected to the at least one processor, via the second PCB, the electrical path, the third PCB, and the first PCB.

4. The electronic device of claim 1,
wherein the first housing part includes a rear plate defining a portion of a rear side of the first housing part positioned outside the second housing part, based on the housing being in the extended state, and
wherein the second portion of the flexible display at least partially overlaps the rear plate, based on the housing being in the retracted state.

5. The electronic device of claim 1, further comprising an electrical path extending from the second PCB, across a lateral side of the second portion of the flexible display perpendicular to a direction in which the second housing part moves, based on the state of the housing being changed, to the third PCB,
wherein the second PCB is disposed on a rear side of the second housing part, the second housing part defining a first through hole at the rear side of the second housing part,
wherein the electronic device further comprises a guide member, configured to guide a movement of the second housing part with respect to the first housing part, defining a second through hole, and
wherein the electrical path passes through the first through hole of the second housing part and the second through hole of the guide member to extend from the second PCB to the third PCB.

6. The electronic device of claim 5,
wherein the electrical path includes:
a first connector positioned to face the second through hole of the guide member,
a first flexible portion extending from the first connector to the second PCB, at least partially bent to pass through the first through hole of the second housing part,
a second connector connected to the first connector, and
a second flexible portion, extending from the second connector to the third PCB, at least partially bent to pass through the second through hole of the guide member.

7. The electronic device of claim 5,
wherein the guide member includes a protruding portion that protrudes toward the second PCB disposed on the rear side of the second housing part to support a portion of the electrical path positioned within the second housing part.

8. The electronic device of claim 7, wherein the protruding portion of the guide member is positioned between the portion of the electrical path and the second portion of the flexible display.

9. The electronic device of claim 5,
wherein the guide member includes:
a first part, including a guide rail, defining the second through hole, and coupled to a lateral side of the second housing part perpendicular to the direction, and
a second part, movably coupled to the guide rail of the first part, coupled to a lateral side of the first housing part corresponding to the lateral side of the second housing part.

10. The electronic device of claim 1, further comprising another electrical path extending from the second PCB, across another lateral side of the second portion of the flexible display opposite to a lateral side of the second portion of the flexible display perpendicular to a direction in which the second housing part moves, based on the state of the housing being changed, to the third PCB.

11. The electronic device of claim 10,
wherein the second housing part includes a conductive portion configured to function as an antenna radiator,
wherein baseband signals, provided from the at least one processor to one or more electronic components electrically connected to the second PCB, are transmitted via the electrical path, and
wherein radio frequency (RF) signals, provided from the conductive portion of the second housing part to the at least one processor, are transmitted via the other electrical path.

12. The electronic device of claim 1,
wherein the second housing part defines an opening at a lateral side of the second housing part perpendicular to the direction,
wherein the slide cover comprises a side plate, coupled to the lateral side of the second housing part to cover the opening.

13. The electronic device of claim 1, further comprising one or more electronic components, disposed in the second housing part, electrically connected to the second PCB,
wherein the at least one processor is electrically connected to the one or more electronic components, via the first PCB, the third PCB, the electrical path, and the second PCB.

14. The electronic device of claim 13,
wherein the one or more electronic components include at least one of:
an inductive coil for wireless charging or short-range wireless communication (SRC),
a microphone, or
a key button for receiving a user input.

15. The electronic device of claim 1,
wherein the slide cover includes a rear cover covering a rear side of the slide cover to cover the second PCB.

16. An electronic device comprising:
a housing including:
a first housing part, and
a second housing part configured to movably engage with the first housing part to provide a retracted state of the housing and an extended state of the housing, the second housing part including a conductive portion configured to function as an antenna radiator;
a flexible display coupled to the first housing part and the second housing part such that a size of an area of the flexible display that is visible from a front side of the housing changes as a state of the housing is changed between the retracted state and the extended state, the flexible display including a portion, when the housing is in the retracted state, positioned within the housing;
a first printed circuit board (PCB) disposed in the first housing part, the first PCB on which at least one processor comprising processing circuitry is disposed;
a second PCB disposed in the second housing part to be positioned behind the portion of the flexible display when the housing is in the retracted state, the second PCB electrically connected to the conductive portion of the second housing part;
a third PCB, disposed in the second housing part, electrically connected to the first PCB, wherein the portion of the flexible display is positioned between the second PCB and the third PCB when the housing is in the retracted state; and
an electrical path extending from the second PCB, across a lateral side of the portion of the flexible display perpendicular to a direction in which the second housing part moves when the state of the housing is changed, to the third PCB,
wherein the third PCB is electrically connected to the second PCB via the electrical path.

17. The electronic device of claim 16,
wherein the conductive portion of the second housing part is electrically connected to the at least one processor, via the second PCB, the electrical path, the third PCB, and the first PCB.

18. The electronic device of claim 16,
wherein the second PCB is disposed on a rear side of the second housing part, the second housing part defining a first through hole at the rear side of the second housing part,
wherein the electronic device further comprises a guide member, configured to guide a movement of the second housing part with respect to the first housing part, defining a second through hole, and
wherein the electrical path passes through the first through hole of the second housing part and the second through hole of the guide member to extend from the second PCB to the third PCB.

19. The electronic device of claim 18,
wherein the electrical path includes:
a first connector positioned to face the second through hole of the guide member,
a first flexible portion extending from the first connector to the second PCB, at least partially bent to pass through the first through hole of the second housing part,
a second connector connected to the first connector, and
a second flexible portion, extending from the second connector to the third PCB, at least partially bent to pass through the second through hole of the guide member, and
wherein the guide member includes a protruding portion that protrudes toward the second PCB disposed on the rear side of the second housing part to support a portion of the electrical path positioned within the second housing part.

20. The electronic device of claim 18,
wherein the guide member includes:
a first part, including a guide rail, defining the second through hole, and coupled to a lateral side of the second housing part perpendicular to the direction, and
a second part, movably coupled to the guide rail of the first part, coupled to a lateral side of the first housing part corresponding to the lateral side of the second housing part.
